(19) United States
(12) Patent Application Publication
(10) Pub. No.: US 2025/0237590 A1
(43) Pub. Date: Jul. 24, 2025

(54) METHOD FOR DETERMINING DATA AVERAGE WIND SPEED VALUE POINT IN CROSS SECTION OF AIR DUCT IN NON-UNIFORM WIND FIELD

(71) Applicant: XI'AN JINGZHAO POWER TECHNOLOGY CO., LTD, Xi'an (CN)

(72) Inventor: Kuanping CAI, Xi'an (CN)

(21) Appl. No.: 19/173,743

(22) Filed: Apr. 8, 2025

Related U.S. Application Data
(63) Continuation of application No. PCT/CN2023/110050, filed on Jul. 29, 2023.
(63) Continuation of application No. PCT/CN2023/110051, filed on Jul. 29, 2023.
(63) Continuation of application No. PCT/CN2023/110052, filed on Jul. 29, 2023.
(63) Continuation of application No. PCT/CN2023/110053, filed on Jul. 29, 2023.

(30) Foreign Application Priority Data
Oct. 19, 2022 (CN) 202211279424.7
Oct. 19, 2022 (CN) 202211280223.9
Oct. 19, 2022 (CN) 202211280595.1
Oct. 19, 2022 (CN) 202211280825.4

(51) Int. Cl. G01N 11/04; F24F 11/30; F24F 110/30

(52) U.S. Cl. CPC G01N 11/04; F24F 11/30; F24F 2110/30; F24F 2221/183

(57) ABSTRACT

A method for determining a data average wind speed value point in the cross section of the air duct. The method includes using, by a controlling, monitoring, and analysis unit A, the air volume flowmeter set in a big data air volume measurement dynamic sensing device in the cross section of the air duct, uniformly distributing preset points in the cross section of the air duct in all-around, measuring the air volume under a monitored load value for each preset point, and calculating an data average value under the monitored load value. The method includes accumulating the wind speed values of all preset points, and dividing by the number of the preset points; and amplifying a data average wind speed error value of a set air duct, until at least one preset point falls within a range of the data average wind speed error value of the set air duct.

### RELATED APPLICATIONS

This application is a continuation of PCT/CN2023/110050, filed on Jul. 29, 2023, which claims the priority of a Chinese Patent Application with an application No.: 202211280595.1 and entitled “METHOD FOR DETERMINING DATA AVERAGE WIND SPEED VALUE POINT IN CROSS SECTION OF AIR DUCT IN NON-UNIFORM WIND FIELD” filed on Oct. 19, 2022; and is a continuation of PCT/CN2023/110051, filed on Jul. 29, 2023, which claims the priority of a Chinese Patent Application with an application No.: 202211280223.9 and entitled “AIR FLOW MEASUREMENT SYSTEM BASED ON BIG DATA ANALYSIS” filed on Oct. 19, 2022; and is a continuation of PCT/CN2023/110052, filed on Jul. 29, 2023, which claims the priority of a Chinese Patent Application with an application No.: 202211279424.7 and entitled “AIR-VOLUME MEASUREMENT METHOD BASED ON BIG-DATA ANALYSIS” filed on Oct. 19, 2022; and is a continuation of PCT/CN2023/110053, filed on Jul. 29, 2023, which claims the priority of a Chinese Patent Application with an application No.: 202211280825.4 and entitled “AIR VOLUME MEASURING SYSTEM FOR NON-UNIFORM WIND FIELD AIR DUCTS” filed on Oct. 19, 2022, the entire contents of which are incorporated in the present application by reference.

### TECHNICAL FIELD

The present invention belongs to the technical field of combustion airflow measurement system, and relates to a method for determining a data average wind speed value point in the cross section of the air duct in non-uniform wind field, and in particular, to a method for determining a data average wind speed value point in the cross section of the air duct in non-uniform wind field based on big data analysis.

### BACKGROUND

In an engineering design of coal-fired generating units, for an overall economic investment of a project, the length of a straight pipe segment of a boiler inlet duct without an apparatus and bending is often less than 1 time the diameter of the air duct or the length of a section side, which is far from meeting provisions in Article 6.2 of the national standard “Measuring the full pipe fluid flow with the differential pressure device mounted in the circular section pipe, Part 4: Venturi Pipe” GB/T2624.4-2006/ISO5167-4:2003 for shortest upstream and downstream straight pipe segments mounted between various pipe fittings and the Venturi pipes. In addition, the inlet duct of the boiler in the coal-fired generating units is provided with a control damper, a support structure, an elbow member, and a baffle, and even a variable diameter segment is further provided at the air duct. The above-mentioned factors renders no wind field at a section of the inlet duct of the boiler to be a uniform wind field, and all to be non-uniform wind field air ducts, which cannot meet the requirements of the air volume measurement device for the front and back straight pipe segments.

The existing air volume measurement device for the above-mentioned non-uniform wind field air duct has the follows:

### 1) An Average Speed Pipe Air Volume Measurement Device

The average speed pipe air volume measurement device is mainly composed of an improved air volume flowmeter based on a Pitot tube speed measurement principle. That is, several pairs of sampling holes (more than two pairs of holes) are respectively and uniformly set at the front and back of a straight pipe segment of the air volume flowmeter along its length direction, to respectively measure a full positive pressure and a full negative pressure of a fluid; then an average differential pressure is measured in the straight pipe segment of the air volume flowmeter to calculate the flow rate of the fluid. The average speed pipe air volume flowmeter is, for example, Powerba, Aniba, Delta, Wilba, Super Liba, etc. The average speed pipe air volume flowmeter has a simple structure, convenient assembly and disassembly, and a small pressure loss. It is more accurate to set it in the air duct of a uniform wind field for air volume measurement. However, when it is set in the air duct of the non-uniform wind field for air volume measurement, because of its own linear setting of multiple pairs of sampling holes (one-dimensional), the differential pressure after the average pressure in the straight pipe segment of the air volume flowmeter cannot accurately represent the actual wind speed value of the cross section of the air duct in the non-uniform wind field, that is, the geometric average wind speed value of the cross section is not equal to the actual wind speed value of the cross section, the air volume value of the air duct cannot be accurately measured.

### 2) Air Volume Measurement Device Based on Venturi Tube Air Volume Flowmeter

In the air volume measurement device based on Venturi tube air volume flowmeter, for the Venturi tube type air volume flowmeter, by using that when a gas flow passing through the air volume flow, it first changes from thick to thin to speed up the gas flow rate, and then forms a “vacuum” area at a rear part of a throat part which changes from thin to thick, a negative pressure sampling hole is disposed in the vacuum area, and the sampling hole and an inlet sampling hole form a differential pressure for air volume measurement. The Venturi tube type air volume flowmeter has advantages of a large differential pressure, a high accuracy and a small resistance loss; it is more accurate to set the Venturi tube type air volume flowmeter in the air duct of a uniform wind field for air volume measurement. However, it cannot ensure the accuracy of air duct air volume measurement when it is set at a single point in the air duct of the non-uniform wind field in a single point manner. Or if it is set in the air duct of the non-uniform wind field in a multi-point geometric uniformity manner for the average differential pressure of the air volume measurement, it cannot accurately measure the average air volume value of the cross section of the air duct in real time, which is determined by the nature of the non-uniform wind field. To some extent, the large differential pressure of the single-point or multi-point Venturi air volume flowmeter may turn into a disadvantage in the non-uniform wind field, amplifying an effect of an error; the Venturi tube type air volume flowmeter is, for example, a single-throat pipe, a double-throat pipe, a multiple-throat pipe, and other air volume flowmeter.

### 3) An Aerofoil Air Volume Measurement Device

The aerofoil air volume measurement device is mainly used for fixedly placing one or more aerofoil-type throttles in the air duct of the wind field with the cross-sectional area of the airflow less than the cross-sectional area of the air duct, and for measuring the air volume of the air duct by using the pressure difference generated before and after a fluid flows through the aerofoil-type throttles. An aerofoil air volume measurement system is widely used in the early low-power coal-fired generating units. Its advantage is that the throttle device is performed in the air duct, and the rectification and measurement functions are included to measure the air volume of the air duct more accurately, but a disadvantage thereof is that its volume is large, the throttle loss is large, the structure is complex, the installation is difficult, and it is easy to jam.

### 4) A Multi-Point Insertion Air Volume Measurement Device

In the air volume measurement device based on the multi-point insertion air volume flowmeter, the multi-point insertion air volume flowmeter mainly is formed by using upper and lower oblique mouth backrest pipes (inserting a steel wire for preventing blocking) to adopt the multi-point geometric average point distribution on the cross section of the air duct, each branch pipe establishing the differential pressure, respectively, then the branch pipe being communicated with an average pressure, and finally leading to a mother pipe. A geometric average wind speed value, that is, the actual wind speed value, is obtained through multiple geometric average pressures, but the geometric average wind speed value is not the approximate actual wind speed value, and the error is particularly large. In addition, in the process of continuous multi-point average pressure air volume measurements, it will cause the measurement gas microflow phenomenon in the average pressure branch pipe, the branch pipe, and the mother pipe backrest pipe, and at the same time, particles in the wind field will be brought into the branch pipe, branch pipe, and mother pipe. This microflow phenomenon exists at all times with changes of load and wind field eddy current, resulting in the mother pipe being quickly blocked by dust, rendering smaller and smaller differential pressures. In order to solve the above-mentioned problem of dust blockage, in the related art, a steel wire vibrating with the wind speed is set in the upper and lower oblique mouth backrest pipes to solve it, but in fact the steel wire only produces wind speed vibration under a specific load wind speed, and would not produce vibration under other load wind speeds except this load. In addition, under normal load, an alternating wind speed in the air duct cannot occur to cause the steel wire to vibrate, either. Therefore, inserting the steel wire in the upper and lower oblique mouth backrest pipes cannot remove the problem of dust blockage in the multi-point insertion air volume flowmeter. Therefore, the air volume measurement system based on a matrix multi-point insertion air volume flowmeter is difficult to accurately measure the air volume in the air duct in the non-uniform wind field according to the geometric uniformly distributed sampling points.

In short, the existing air volume measurement technology cannot accurately measure the air volume in the air duct of the non-uniform wind field in real time, and in particular, in the inlet duct of the coal-fired boiler.

### SUMMARY

To solve the problem in the related art above that the air volume of the air duct in the non-uniform wind field is inaccurately measured, the present invention further provides a method for determining a data average wind speed value point in the cross section of the air duct in a non-uniform wind field: using, by a controlling, monitoring, and analysis unit A, the air volume flowmeter set in a big data air volume dynamic sensing device in the cross section of the air duct to measure a wind speed for one time in an all-around dynamic point-by-point manner at a provided preset point interval, and convert same into an electrical signal air volume value through an air volume transmitter at the same time, and then store the air duct load value, a preset point of the air duct thereof, and the measured electrical signal air volume value during a sampling period in the controlling, monitoring, and analysis unit A in the one-to-one correspondence, until the measured air duct load value changes once and the wind speed measurement is completed;
calculating, by the controlling, monitoring, and analysis unit A, a data average wind speed value under the monitored load value, respectively: accumulating the wind speed values of the preset points under the monitored load value, respectively, and then dividing same by the number of the preset point, respectively; and
adjusting and setting a data average wind speed error value of the air duct to be gradually increased from zero, until at least one preset point under the monitored load value falls within a range of the data average wind speed error value of the air duct, where the preset point is the data average wind speed value point,
   wherein the air duct in the non-uniform wind field is an intake duct of a coal-fired boiler for a coal-fired generating unit.

Preferably, there are at least two data average wind speed value points.

Preferably, a value range of the monitored load values is 35%-100%, and at least one monitored load value is selected in the range thereof.

Preferably, 7 different load values are selected in a uniformly distributed manner in the value range of the monitored load values.

Preferably, the big data air volume dynamic sensing device includes a sensing active part, a driven air volume sensing part thereof, and a sensing active part driving part; the sensing active part driving part includes a transmission part for transmitting the sensing active part, and a driving part thereof; the driven air volume sensing part includes a dynamic air volume sensing member and a rotating part on the sensing active part for moving the dynamic air volume sensing member back and forth; or the driven air volume sensing part includes a plurality of air volume flowmeters uniformly distributed on the sensing active part.

Preferably, the big data air volume dynamic sensing device is a big data air volume dynamic longitude and latitude sensing device or a big data air volume dynamic axial and radial sensing device.

Preferably, the big data air volume dynamic longitude and latitude sensing device includes a longitude sensing active part, a latitude driven air volume sensing part thereof, and a longitude sensing active part driving part; and the longitude sensing active part driving part includes a vertical transmission part for transmitting the longitude sensing active part in a longitude direction, and a vertical driving part thereof.

Preferably, the latitude driven air volume sensing part includes a latitude dynamic air volume sensing member and a transverse rotating part on the air duct on the longitude sensing active part for transversely moving the latitude dynamic air volume sensing member back and forth.

Preferably, the latitude dynamic air volume sensing member includes a sliding block and one air volume flowmeter fixed thereon.

Preferably, the latitude driven air volume sensing part includes a plurality of air volume flowmeters uniformly distributed on the longitude sensing active part.

Preferably, the number of the air volume transmitters is the same as that configured for the air volume flowmeters, and they are respectively communicated with respective sampling pipes.

Preferably, the air volume flowmeter is at least one of a Pitot tube air volume flowmeter and a Venturi type air volume flowmeter.

Preferably, the Venturi type air volume flowmeter is at least one of a single-throat pipe air volume flowmeter, a double-throat pipe air volume flowmeter, and a multi-throat pipe air volume flowmeter.

Preferably, the longitude sensing active part includes a transverse part and a vertical part; a cross section of a transverse part body is an inverted C-type structure; a vertical part body is a long strip shaped closed housing; the transverse part body and the vertical part body are welded together to form an inverted T-type structure; the transverse rotating part includes left and right transverse fixed pulleys respectively disposed at two ends of the transverse part body and exposed from a top surface of the transverse part body, left and right corner fixed pulleys respectively disposed at two inner sides of a lower end in the vertical part body, an upper fixed pulley disposed at an inner sider of an upper end thereof, a transverse rotating steel wire wound on the left and right transverse fixed pulleys and the left and right corner fixed pulleys, and the upper fixed pulley, and a transverse stepping motor for driving the upper fixed pulley; and the latitude dynamic air volume sensing member is fixed at a lower end of the transverse part body and disposed on the transverse rotating steel wire.

Preferably, the vertical transmission part includes a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and is fixed on an upper end surface of the vertical transmission part body and axially drives the vertical screw.

Preferably, the longitude sensing active part includes a transverse part and a vertical part; a cross section of a transverse part body is an inverted C-type structure; a vertical part body is a long strip shaped closed housing; the transverse part body and the vertical part body are welded together to form an inverted T-type structure; and the air volume flowmeter is fixed at a lower end of the transverse part body.

Preferably, the vertical transmission part includes a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and is fixed on an upper end surface of the vertical transmission part body and axially drives the vertical screw.

The present invention uses the air volume flowmeter of a big data air volume measurement dynamic sensing device set in the cross section of the air duct in the non-uniform wind field to perform big data analysis on the wind speed measurement values of all the preset points of the air duct under the monitored load value to find the average wind speed value point of the air duct data; in this way, the air volume flowmeter can only be set at the average wind speed value point of the air duct data to measure the wind speed of the air duct, so that the average wind speed value of the cross section data of the air duct represents the actual wind speed of the cross section, which solves the problem that a geometric average wind speed value of the air volume measurement device in the related art is not accurate in measuring the air volume of the air duct.

In order to solve the problem in the related art that the air volume of the air duct in the non-uniform wind field is inaccurately measured, the present invention provides an accurate air volume measurement system based on big data analysis in real time, which includes at least setting a big data air volume dynamic sensing device in the cross section of the air duct in the non-uniform wind field, the air volume transmitter connected thereto, and a controlling, monitoring, and analysis unit A for controlling and monitoring them, wherein the air duct in the non-uniform wind field is an intake duct of a coal-fired boiler for a coal-fired generating unit.

Preferably, the big data air volume dynamic sensing device includes a sensing active part, a driven air volume sensing part thereof, and a sensing active part driving part; the sensing active part driving part includes a transmission part for transmitting the sensing active part, and a driving part thereof; the driven air volume sensing part includes a dynamic air volume sensing member and a rotating part on the sensing active part for moving the dynamic air volume sensing member back and forth; or the driven air volume sensing part includes a plurality of air volume flowmeters uniformly distributed on the sensing active part.

Preferably, the big data volume dynamic sensing device is a big data air volume dynamic longitude and latitude sensing device, which includes a longitude sensing active part, a latitude driven air volume sensing part thereof, and a longitude sensing active part driving part; and the longitude sensing active part driving part includes a vertical transmission part for transmitting the longitude sensing active part in a longitude direction, and a vertical driving part thereof.

Preferably, the latitude driven air volume sensing part includes a latitude dynamic air volume sensing member and a transverse rotating part on the air duct on the longitude sensing active part for transversely moving the latitude dynamic air volume sensing member back and forth.

Preferably, the latitude dynamic air volume sensing member includes a sliding block and one air volume flowmeter fixed thereon.

Preferably, the latitude driven air volume sensing part includes a plurality of air volume flowmeters uniformly distributed on the longitude sensing active part.

Preferably, the number of the air volume transmitters is the same as that configured for the air volume flowmeters, and they are respectively communicated with respective sampling pipes, or the air volume flowmeter is connected to the air volume transmitter through positive and negative equalizers.

Preferably, the air volume flowmeter is at least one of a Pitot tube air volume flowmeter and a Venturi type air volume flowmeter.

Preferably, the Venturi type air volume flowmeter is at least one of a single-throat pipe air volume flowmeter, a double-throat pipe air volume flowmeter, and a multi-throat pipe air volume flowmeter.

Preferably, the longitude sensing active part includes a transverse part and a vertical part; a cross section of a transverse part body is an inverted C-type structure; a vertical part body is a long strip shaped closed housing; the transverse part body and the vertical part body are welded together to form an inverted T-type structure; the transverse rotating part includes left and right transverse fixed pulleys respectively disposed at two ends of the transverse part body and exposed from a top surface of the transverse part body, left and right corner fixed pulleys respectively disposed at two inner sides of a lower end in the vertical part body, an upper fixed pulley disposed at an inner sider of an upper end thereof, a transverse rotating steel wire wound on the left and right transverse fixed pulleys and the left and right corner fixed pulleys, and the upper fixed pulley, and a transverse stepping motor for driving the upper fixed pulley; and the latitude dynamic air volume sensing member is fixed at a lower end of the transverse part body and disposed on the transverse rotating steel wire.

Preferably, the vertical transmission part includes a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and is fixed on an upper end surface of the vertical transmission part body and axially drives the vertical screw.

Preferably, the longitude sensing active part includes a transverse part and a vertical part; a cross section of a transverse part body is an inverted C-type structure; a vertical part body is a long strip shaped closed housing; the transverse part body and the vertical part body are welded together to form an inverted T-type structure; and the air volume flowmeter is fixed at a lower end of the transverse part body.

Preferably, the vertical transmission part includes a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and is fixed on an upper end surface of the vertical transmission part body and axially drives the vertical screw.

Preferably, the big data air volume dynamic sensing device is a big data air volume dynamic axial and radial sensing device, which includes an axial sensing active part, a radial driven air volume sensing part thereof, and an axial sensing active part driving part; and the axial sensing active part driving part includes an axial transmission part for axially transmitting the axial sensing active part, and an axial driving part thereof.

Preferably, the radial driven air volume sensing part includes a radial dynamic air volume sensing member and a radial rotating part of the air duct on the axial sensing active part for radially moving the radial dynamic air volume sensing member back and forth.

Preferably, the radial dynamic air volume sensing member includes a sliding block A and one air volume flowmeter A fixed thereon.

Preferably, the radial driven air volume sensing part includes a plurality of air volume flowmeters A uniformly distributed on the axial sensing active part.

Preferably, the number of the air volume transmitters is the same as that configured for the air volume flowmeters A, and they are respectively communicated with respective sampling pipes, or the air volume flowmeter A is connected to the air volume transmitter through positive and negative equalizers.

Preferably, the air volume flowmeter A is at least one of a Pitot tube air volume flowmeter and a Venturi type air volume flowmeter.

Preferably, the Venturi type air volume flowmeter is at least one of a single-throat pipe air volume flowmeter, a double-throat pipe air volume flowmeter, and a multi-throat pipe air volume flowmeter.

Preferably, the axial sensing active part includes an axial sensing active part body, the cross section of the axial sensing active part body is a C-type structure, and an opening thereof is located on a right side thereof; the radial rotating part includes a center fixed pulley and a circumferential fixed pulley respectively disposed at both ends of the axial sensing active part body, a dynamic radial transmission steel wire therebetween, a static transmission part for axially driving the center fixed pulley to rotate, and a radial stepping motor for driving same; the radial dynamic air volume sensing member is fixed on an opening side of the axial sensing active part body and is arranged on the dynamic radial transmission steel wire.

Preferably, the axial transmission part includes an axial transmission part body with the cross section being an I-shaped structure and a front side located at the center of a circular air duct, a center inner fixed pulley and a right end inner fixed pulley respectively disposed at positions of a right end thereof, and a static axial transmission steel wire therebetween; two ends of the axial transmission part body are respectively fixed on left and right walls of the circular air duct through the center of the circular air duct and the right end extends out of the air duct outer wall; the axial driving part is an axial stepping motor, which is fixed on the axial driving part body and is connected to and drives the right end inner fixed pulley through a shaft;
the axial sensing active part body is also provided with a sleeve at a center point of the air duct thereof, an end of the sleeve is fixed on the axial sensing active part body at the center point of the circular air duct, and the other end thereof is fixed between inner and outer bearings in a vertical bar of the I-shaped structure of the axial transmission part body; and an inner wall of the center inner fixed pulley is embedded in an outer wall of the sleeve;
the static transmission part includes the axial transmission part body with a rear side located at the center of the circular air duct and a right end respectively provided with a center outer fixed pulley, a right end outer fixed pulley, and a static radial transmission steel wire therebetween; the radial stepping motor is fixed on the axial transmission part body and is connected to and drives the right end outer fixed pulley through a shaft; and the center outer fixed pulley is connected to and drives the center fixed pulley to rotate through a connecting shaft, and the connecting shaft between the center outer fixed pulley and the center fixed pulley is embedded in the inner bearing.

Preferably, the axial transmission part includes an axial transmission part body with the cross section being an I-shaped structure and a front side located at the center of the circular air duct, a center inner fixed pulley and a right end inner fixed pulley respectively disposed at positions of a right end thereof, and a static axial transmission steel wire therebetween; the axial transmission part body is fixed on left and right walls of the circular air duct through the center of the circular air duct and the right end extends out of the air duct outer wall; the axial driving part is an axial stepping motor, which is fixed on the axial driving part body and is connected to and drives the right end inner fixed pulley through a shaft;
the axial sensing active part body is also provided with a sleeve at a center point of the air duct thereof, an end of the sleeve is fixed on the axial sensing active part body at the center point of the circular air duct, and the other end thereof is fixed between inner and outer bearings in a vertical bar of the I-shaped structure of the axial transmission part body; and an inner wall of the center inner fixed pulley is embedded in an outer wall of the sleeve.

The present invention uses a big data air volume measurement dynamic sensing device set in the cross section of the air duct in the non-uniform wind field, and uniformly distributing preset points all-around in the cross section of the air duct, and using the data average wind speed value of the cross section of the air duct for representing the actual cross section wind speed, which solves the problem that a geometric average wind speed value of the air volume measurement device in the existing art is not accurate in measuring the air volume of the air duct. In particular, the technical solution of the present invention is applied to the coal-fired boiler of the coal-fired generating unit to make it more accurately reach or close to its best wind coal ratio, so as to greatly improve the safety and combustion efficiency of the coal-fired boiler, which is energy saving and environmentally protective, and improves the flexible power generation of the coal-fired generating unit at the same time, so that the economic benefits are obvious, so as to improve stable operation of the whole power grid.

To solve the problem in the related art above that the air volume of the air duct in the non-uniform wind field is inaccurately measured, the present invention further provides a method for accurately measuring the air volume in real time based on big data analysis: using, by a controlling, monitoring, and analysis unit A, the air volume flowmeter at least set in a big data air volume dynamic sensing device within the cross section of the air duct to measure an all-around dynamic point-by-point air volume in each sampling period at a preset point interval; then sending the measured air volume electrical signal to the controlling, monitoring, and analysis unit A through the air volume transmitter; and then accumulating the air volume measurement values at all preset points and then dividing same by the number of the preset points, to obtain a data average wind speed value, wherein the air duct in the non-uniform wind field is an intake duct of a coal-fired boiler for a coal-fired generating unit.

Preferably, the big data air volume dynamic sensing device includes a sensing active part, a driven air volume sensing part thereof, and a sensing active part driving part; the sensing active part driving part includes a transmission part for transmitting the sensing active part, and a driving part thereof; the driven air volume sensing part includes a dynamic air volume sensing member and a rotating part on the sensing active part for moving the dynamic air volume sensing member back and forth; or the driven air volume sensing part includes a plurality of air volume flowmeters uniformly distributed on the sensing active part.

Preferably, the big data air volume dynamic sensing device is a big data air volume dynamic longitude and latitude sensing device or a big data air volume dynamic axial and radial sensing device.

Preferably, the big data air volume dynamic longitude and latitude sensing device includes a longitude sensing active part, a latitude driven air volume sensing part thereof, and a longitude sensing active part driving part; and the longitude sensing active part driving part includes a vertical transmission part for transmitting the longitude sensing active part in a longitude direction, and a vertical driving part thereof.

Preferably, the latitude driven air volume sensing part includes a latitude dynamic air volume sensing member and a transverse rotating part on the air duct on the longitude sensing active part for transversely moving the latitude dynamic air volume sensing member back and forth.

Preferably, the latitude dynamic air volume sensing member includes a sliding block and one air volume flowmeter fixed thereon.

Preferably, the latitude driven air volume sensing part includes a plurality of air volume flowmeters uniformly distributed on the longitude sensing active part.

Preferably, the number of the air volume transmitters is the same as that configured for the air volume flowmeters, and they are respectively communicated with respective sampling pipes, or the air volume flowmeter is connected to the air volume transmitter through positive and negative equalizers; and the number of the preset points is the number of measurement points moved in the longitude direction by the longitude sensing active part.

Preferably, the air volume flowmeter is at least one of a Pitot tube air volume flowmeter and a Venturi type air volume flowmeter.

Preferably, the Venturi type air volume flowmeter is at least one of a single-throat pipe air volume flowmeter, a double-throat pipe air volume flowmeter, and a multi-throat pipe air volume flowmeter.

Preferably, the longitude sensing active part includes a transverse part and a vertical part; a cross section of a transverse part body is an inverted C-type structure; a vertical part body is a long strip shaped closed housing; the transverse part body and the vertical part body are welded together to form an inverted T-type structure; the transverse rotating part includes left and right transverse fixed pulleys respectively disposed at two ends of the transverse part body and exposed from a top surface of the transverse part body, left and right corner fixed pulleys respectively disposed at two inner sides of a lower end in the vertical part body, an upper fixed pulley disposed at an inner sider of an upper end thereof, a transverse rotating steel wire wound on the left and right transverse fixed pulleys and the left and right corner fixed pulleys, and the upper fixed pulley, and a transverse stepping motor for driving the upper fixed pulley; and the latitude dynamic air volume sensing member is fixed at a lower end of the transverse part body and disposed on the transverse rotating steel wire.

Preferably, the vertical transmission part includes a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and is fixed on an upper end surface of the vertical transmission part body and axially drives the vertical screw.

Preferably, the longitude sensing active part includes a transverse part and a vertical part; a cross section of a transverse part body is an inverted C-type structure; a vertical part body is a long strip shaped closed housing; the transverse part body and the vertical part body are welded together to form an inverted T-type structure; and the air volume flowmeter is fixed at a lower end of the transverse part body.

Preferably, the vertical transmission part includes a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and is fixed on an upper end surface of the vertical transmission part body and axially drives the vertical screw.

The present invention uses the air volume flowmeter of the big data air volume measurement dynamic sensing device set in the cross section of the air duct in the non-uniform wind field, uniformly distributes preset points all-around in the cross section of the air duct, and performs big data air volume measurement for each preset point to obtain the data average wind speed value of the air duct, and in this way, the data average wind speed value of the cross section of the air duct is used for representing the actual cross section wind speed, which solves the problem that a geometric average wind speed value of the air volume measurement device in the related art is not accurate in measuring the air volume of the air duct. In particular, the technical solution of the present invention is applied to the coal-fired boiler of the coal-fired generating unit to make it more accurately reach or close to its best wind coal ratio, so as to greatly improve the safety and combustion efficiency of the coal-fired boiler, which is energy saving and environmentally protective, and improves the flexible power generation of the coal-fired generating unit at the same time, so that the economic benefits are obvious, so as to improve stable operation of the whole power grid.

In order to solve the problem in the related art that the air volume of the air duct in the non-uniform wind field is inaccurately measured, the present invention further provides the air volume measurement system for setting the air volume flowmeter based on an average wind speed value point of data within the cross section of the air duct in the non-uniform wind field, including the air volume flowmeter B set on at least one data average wind speed point within the cross section of the air duct, the air volume transmitter connected thereto, and a controlling, monitoring, and analysis unit B for controlling and monitoring them, wherein the air duct in the non-uniform wind field is an intake duct of a coal-fired boiler for a coal-fired generating unit.

Preferentially, the air volume flowmeter B is provided at least two the data average wind speed value points within the cross section of the air duct, respectively.

Preferably, the number of the air volume transmitters B is the same as that configured for the air volume flowmeters B, and they are respectively communicated with respective sampling pipes, or the air volume flowmeter B is connected to the air volume transmitter B through positive and negative equalizers.

Preferably, the air volume flowmeter B is at least one of a Pitot tube air volume flowmeter and a Venturi type air volume flowmeter.

Preferably, the Venturi type air volume flowmeter is at least one of a single-throat pipe air volume flowmeter, a double-throat pipe air volume flowmeter, and a multi-throat pipe air volume flowmeter.

The present invention uses the air volume flowmeter set at the data average wind speed value point within the cross section of the air duct in the non-uniform wind field to measure the wind speed value of the air duct, and using the data average wind speed value of the cross section of the air duct for representing the actual cross section wind speed, which solves the problem that a geometric average wind speed value of the air volume measurement device in the related art is not accurate in measuring the air volume of the air duct. In particular, the technical solution of the present invention is applied to the coal-fired boiler of the coal-fired generating unit to make it more accurately reach or close to its best wind coal ratio, so as to greatly improve the safety and combustion efficiency of the coal-fired boiler, which is energy saving and environmentally protective, and improves the flexible power generation of the coal-fired generating unit at the same time, so that the economic benefits are obvious, so as to improve stable operation of the whole power grid.

### BRIEF DESCRIPTION OF DRAWINGS

FIG. 1 is a schematic diagram of a front structure of a big data air volume measurement dynamic longitude and latitude sensing device disposed in a rectangular air duct provided by embodiment I;

FIG. 2 is a schematic diagram of a lateral profile structure in an A-A direction of the big data air volume measurement dynamic longitude and latitude sensing device disposed in the rectangular air duct in FIG. 1;

FIG. 3 is a schematic diagram of a plane layout of a primary hot air duct entry segment entering a ball mill in a simulated 300 MW coal-fired generator set of the air volume measurement system based on big data analysis provided by embodiment I;

FIG. 4 is a schematic diagram of a vertical face layout in a B-B direction of the primary hot air duct entry segment entering the ball mill in FIG. 3;

FIG. 5A is a 3D wind speed measurement curve diagram of the air volume measurement system when a load value of the simulated air duct segment in FIG. 3 is 33%;

FIG. 5B is a 3D wind speed measurement curve diagram of the air volume measurement system when the load value of the simulated air duct segment in FIG. 3 is 41.7%;

FIG. 5C is a 3D wind speed measurement curve diagram of the air volume measurement system when the load value of the simulated air duct segment in FIG. 3 is 58.3%;

FIG. 5D is a 3D wind speed measurement curve diagram of the air volume measurement system when the load value of the simulated air duct segment in FIG. 3 is 70%;

FIG. 5E is a 3D wind speed measurement curve diagram of the air volume measurement system when the load value of the simulated air duct segment in FIG. 3 is 87.6%;

FIG. 5F is a 3D wind speed measurement curve diagram of the air volume measurement system when the load value of the simulated air duct segment in FIG. 3 is 100%;

FIG. 6 is a 3D curve diagram of selecting a data average wind speed value point of the air volume measurement system based on big data analysis of the simulated air duct segment in FIG. 3 when a set data average wind speed value error is 6/4500;

FIG. 7 is a flow chart of the air volume measurement method based on big data analysis provided by the present invention;

FIG. 8 is a flow chart of a method for determining a data average wind speed value point by the air volume measurement system based on big data analysis provided by the present invention;

FIG. 9 is a flow chart of a correction method of combining the air volume measurement system based on big data analysis and the air volume measurement system provided with the air volume flowmeter based on a data average wind speed value point provided by the present invention;

FIG. 10 is a schematic diagram of a front structure of a big data air volume measurement dynamic axial and radial sensing device disposed in a circular air duct provided by embodiment II; and

FIG. 11 is a schematic diagram of a lateral profile structure in a C-C direction of the big data air volume measurement dynamic axial and radial sensing device disposed in the circular air duct in FIG. 10.

### REFERENCE NUMERALS IN THE DRAWINGS

1 rectangular air duct; 2 longitude sensing active part driving part, 2-1 vertical transmission part, 2-1-1 vertical transmission part body, 2-1-2 upper fixed seat, 2-1-3 lower fixed seat, 2-1-4 vertical screw, 2-1-5 vertical track, 2-2 vertical driving part; 3 longitude sensing active part, 3-1 transverse part, 3-1-1 transverse part body, 3-1-2 transverse track, 3-2 vertical part, 3-2-1 vertical part body, 3-2-2 nut; 4 latitude driven air volume sensing part, 4-1 latitude dynamic air volume sensing member, 4-1-1 sliding block, 4-1-2 air volume flowmeter, 4-2 transverse rotating part, 4-2-1 left transverse fixed pulley, 4-2-2 right transverse fixed pulley, 4-2-3 left corner fixed pulley, 4-2-4 right corner fixed pulley, 4-2-5 upper fixed pulley, 4-2-6 transverse rotating steel wire, and 4-2-7 transverse stepping motor;
1′ circular air duct; 5 axial sensing active part, 5-1 axial sensing active part body, 5-1-1 transverse track A, 5-1-2 sleeve; 6 radial driven air volume sensing part, 6-1 radial dynamic air volume sensing member, 6-1-1 sliding block A, 6-1-2 air volume flowmeter A, 6-2 radial rotating part, 6-2-1 center fixed pulley, 6-2-2 circumferential fixed pulley, 6-2-3 dynamic radial transmission steel wire, 6-2-4 static transmission part, 6-2-6 center outer fixed pulley; 7-1 axial transmission part, 7-1-1 axial transmission part body, 7-1-2 center inner fixed pulley, 7-1-3 right end inner fixed pulley, and 7-1-4 static axial transmission steel wire;
10 ball mill, 11 expansion joint A, 12 expansion joint B, 13 cold air pipe, 14 cold air port, 15 shutoff valve, 16 adjusting valve, 17 expansion joint C, 0.00 elevation 0.00 meter, 2.235 elevation 2.235 meters, 6.10 elevation 6.10 meters, and 8.30 elevation 8.30 meters.

### DETAILED DESCRIPTION

The concept for the big data air volume dynamic sensing device is: a sensing device capable of respectively measuring the wind speed thereof one by one for a plurality of points that are evenly or basically uniformly distributed in the cross section of a perpendicular gas flow direction in the air duct of the non-uniform wind field, so as to measure the wind speed of the air duct in an all-around manner and determine the data average wind speed value or/and data average wind speed value point of the air duct of the non-uniform wind field through big data analysis. For example, a big data air volume dynamic longitude and latitude sensing device and a big data air volume dynamic axial and radial sensing device.

The big data air volume dynamic sensing device includes a sensing active part, a driven air volume sensing part thereof, and a sensing active part driving part; the sensing active part driving part includes a transmission part for transmitting the sensing active part, and a driving part thereof (the longitude direction or axial direction sampling); the driven air volume sensing part includes a dynamic air volume sensing member and a rotating part on the sensing active part for moving the dynamic air volume sensing member back and forth (the latitude direction or radial direction sampling); or the driven air volume sensing part includes a plurality of air volume flowmeters uniformly distributed on the sensing active part (the latitude direction or radial direction sampling).

The big data air volume dynamic sensing device is disposed in the cross section of the air duct in the non-uniform wind field, is communicated with the air volume transmitter, and the controlling, monitoring, and together with analysis unit A that controls and monitors them, forms the air volume measurement system based on big data analysis.

The controlling, monitoring, and together with analysis unit A controls the big data air volume dynamic sensing device under a specific load value of a certain air duct to measure the wind speed one by one for a plurality of points that are evenly or basically uniformly distributed in the cross section of a perpendicular gas flow direction, so as to measure the wind speed of the air duct in an all-around manner and obtain the data average wind speed value or determine a corresponding point.

The present invention is further explained in combination with the attached drawings and the specific embodiments. It should be understood that the following specific embodiments are intended only to illustrate the present invention and not to limit the scope of the present invention.

### Embodiment I

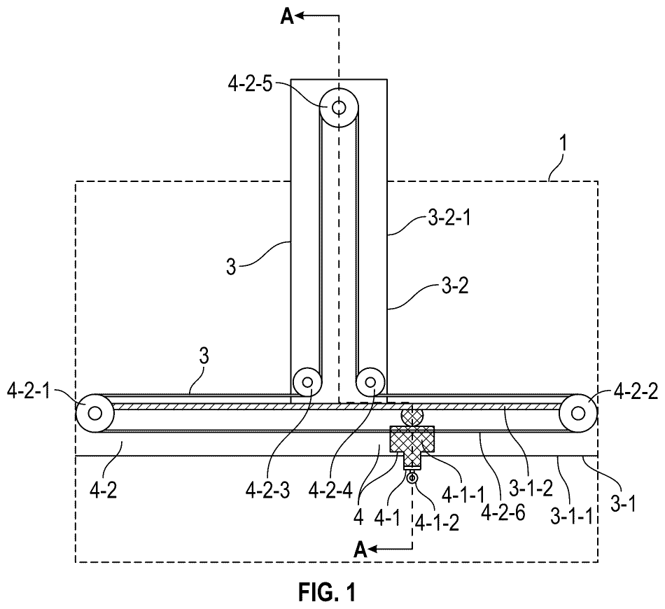

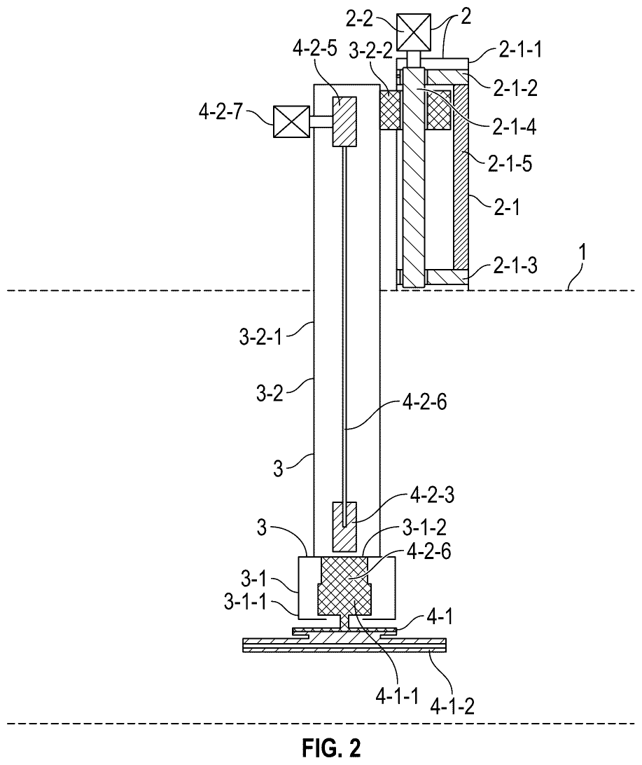

As shown in FIG. 1 and FIG. 2, it is a schematic diagram of a structure of a big data air volume dynamic longitude and latitude sensing device disposed in a rectangular air duct provided by the present invention. A big data air volume dynamic sensing device is a big data air volume dynamic longitude and latitude sensing device; and the big data air volume dynamic longitude and latitude sensing device is disposed in a certain cross section of a rectangular air duct 1, and includes a longitude sensing active part 3, a latitude driven air volume sensing part 4 thereof, and a longitude sensing active part driving part 2; the longitude sensing active part driving part 2 includes a vertical transmission part 2-1 for transmitting the longitude sensing active part in a longitude direction, and a vertical driving part 2-2 thereof; the latitude driven air volume sensing part 4 includes a latitude dynamic air volume sensing member 4-1 and a transverse rotating part 4-2 on the air duct of the longitude sensing active part for moving the latitude dynamic air volume sensing member 4-1 back and forth (the X axis direction is the latitude direction).

The longitude sensing active part 3 includes a transverse part 3-1 and a vertical part 3-2; a body of the longitude sensing active part 3 is transversely an inverse T-type structure; a cross section of a transverse part body 3-1-1 is an inverted C-type structure; an inner top surface of the C-type structure is provided with a transverse track 3-1-2; a vertical part body 3-2-1 is a long strip shaped closed housing; the transverse part body 3-1-1 and the vertical part body 3-2-1 are welded together to form an inverted T-type structure; and a nut 3-2-2 is disposed at an upper end of a rear side of the vertical part body.

The transverse rotating part 4-2 includes left and right transverse fixed pulleys 4-2-1 and 4-2-2 respectively disposed at both ends of the transverse part body 3-1-1 and a part thereof exposing out of the top surface of the transverse part body 3-1-1, left and right corner fixed pulleys 4-2-3 and 4-2-4 respectively disposed at two inner sides of a lower end in the vertical part body 3-2-1, an upper fixed pulley 4-2-5 disposed on an upper end in the vertical part body 3-2-1, a transverse rotating steel wire 4-2-6 wound on the left and right transverse fixed pulleys, the left and right corner fixed pulleys, and the upper fixed pulley, and a transverse stepping motor 4-2-7 for driving the upper fixed pulley.

The latitude dynamic air volume sensing piece 4-1 is fixed on the lower end of the transverse part body and is arranged on the transverse rotating steel wire 4-2-6; the latitude dynamic air volume sensing device 4-1 includes a sliding block 4-1-1 sliding along a transverse track and the air volume flowmeter 4-1-2 fixed on it and located below the C-type structure of the transverse part body.

The vertical transmission part 2-1 includes a vertical transmission part body 2-1-1, upper and lower fixed seats 2-1-2 and 2-1-3 further with bearings respectively in upper and lower ends thereof, and a vertical screw 2-1-4 fixed in the bearings of the upper and lower fixed seats; and the vertical driving part 2-2 is a vertical stepping motor, and is fixed on an upper end surface of the transmission part body 2-1-1 and axially drives the vertical screw 2-1-4. The cross section of the vertical transmission part body 2-1-1 is a groove-type structure, the bottom of the groove-type structure is provided with a vertical track 2-1-5 (in order to make the nut 3-2-2 slide smoothly up and down in the groove), and it is integrally and vertically fixed on an outer wall above the rectangular air duct 1; in this way, the longitude sensing active part 3 is entirely driven by moving the nut 3-2-2 up and down on the vertical screw 2-1-4 (the Y axis direction is the longitude direction).

The rectangular air duct air volume measurement system composed of the big data air volume dynamic longitude and latitude sensing device also includes the air volume transmitter connected with the air volume flowmeter in the big data air volume dynamic longitude and latitude sensing device and a controlling, monitoring, and analysis unit A that controls and monitors the big data air volume dynamic longitude and latitude sensing device.

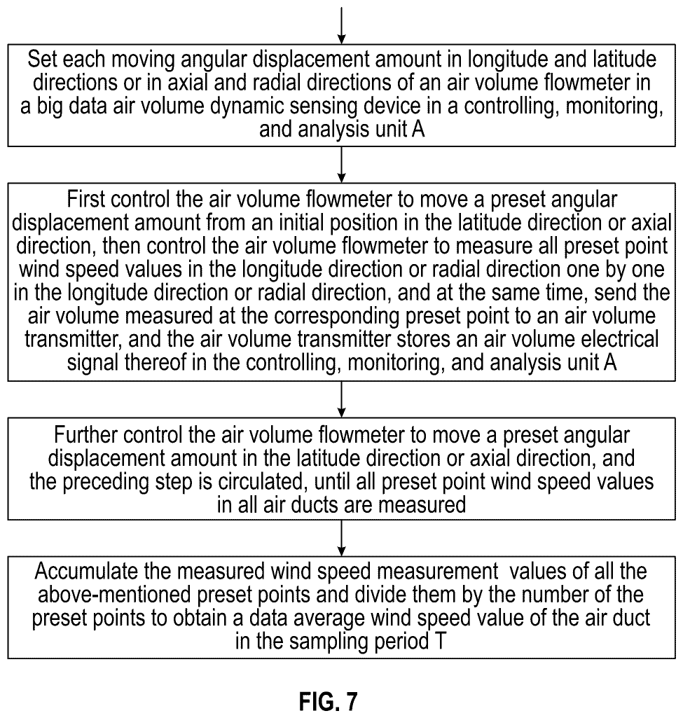

As shown in FIG. 7, this embodiment provides a flow chart of the air volume measurement method based on big data analysis of the air duct of a non-uniform wind field based on the afore-mentioned rectangular air duct air volume measurement system, and the steps thereof are as follows:
1) In the controlling, monitoring, and analysis unit A, each angular displacement amount of the air volume flowmeter in the longitude and latitude directions is set (i.e., in the controlling, monitoring, and analysis unit A, setting each moving displacement size of the air volume flowmeter in the transverse (the X axis direction is the latitude direction) and the vertical (the Y axis direction is the longitude direction) directions, i.e., respectively setting each preset angular displacement amount of the transverse stepping motor and the vertical stepping motor; where each angular displacement amount in the two directions can be the same or can be different).
2) The controlling, monitoring, and analysis unit A first controls the air volume flowmeter from an initial position to a longitude movement by a preset angular displacement amount, then controls the air volume flowmeter to measure all the latitude preset point wind speed values (i.e., the differential pressure values) one by one in the latitude direction, and at the same time, sends the air volume measured at the corresponding preset point to the air volume transmitter. Then the air volume transmitter stores the air volume electrical signal thereof in the controlling, monitoring, and analysis unit A (i.e., the controlling, monitoring, and analysis unit A first controls the vertical stepping motor to move a preset angular displacement amount, and then controls the transverse stepping motor to drive the upper fixed puller to drive the transverse rotating steel wire 4-2-6 to rotate a preset angular displacement amount. In this way, the air volume flowmeter is driven to transversely measure the wind speed value of all the preset points in the transverse direction one by one, at the same time, the wind speed value measured at the corresponding preset point (i.e., the pressure difference) is sent to the air volume transmitter, and then the air volume transmitter stores its air volume electrical signal in the controlling, monitoring, and analysis unit A).
3) The controlling, monitoring, and analysis unit A further controls the vertical stepping motor to move a preset angular displacement amount, and step 2 is circulated, until the air volume flowmeter measures all preset point wind speed values in the rectangular air duct in an all-around manner.
4) The controlling, monitoring, and analysis unit accumulates the measured wind speed values of all the above-mentioned preset points and divided them by the number of the preset points of the rectangular air duct to obtain the data average wind speed value of the air duct in the sampling period T, where this value is the measured value of air volume in the air duct.

The wind speed measurement of all the preset points in the whole rectangular air duct above requires a sampling period T, but the size of the sampling period T is determined by the size of the transverse stepping motor and vertical stepping motor speed, the size of the rectangular air duct, the number of preset points of the rectangular air duct, the size of the wind speed of the rectangular air duct, and other factors. The shorter the sampling period T, the more accurate the data average wind speed value of the air duct above. However, when the air duct load value is constant, the size of the data average wind speed value of the air duct above is irrelevant with the sampling period T.

The preset point interval is determined by the size of the air duct, the complexity of the wind field, the accuracy of the air volume measurement thereof, and other requirements.

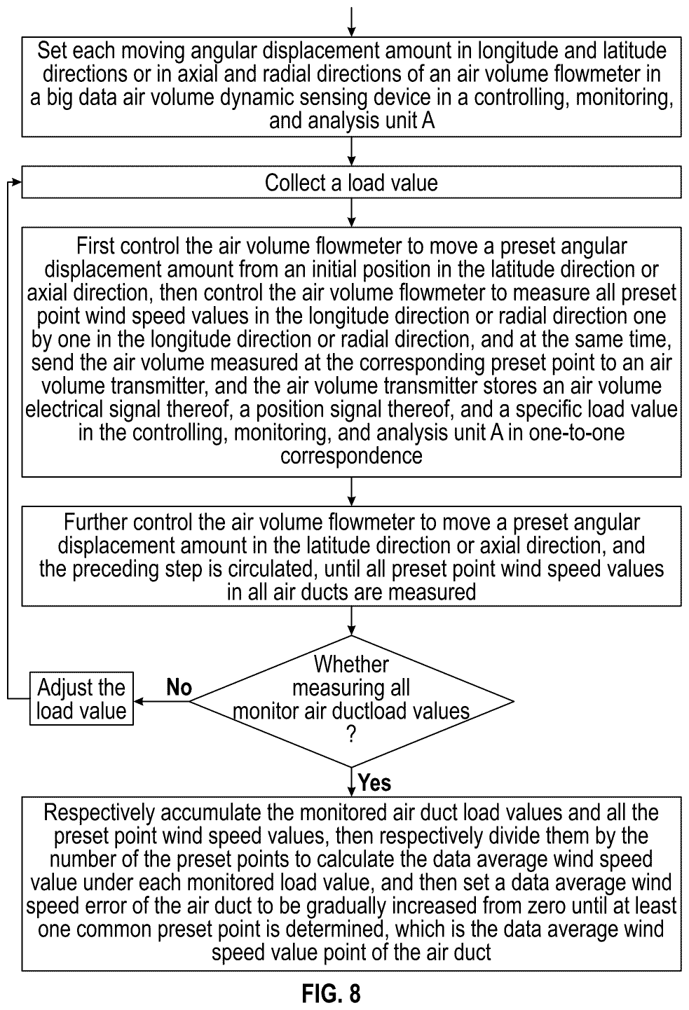

As shown in FIG. 8, this embodiment further provides a method for determining a data average wind speed value point through the afore-mentioned air volume measurement system of the air duct of the non-uniform wind field based on the rectangle air duct air volume measurement system, and the steps thereof are as follows:
1) In the controlling, monitoring, and analysis unit A, each angular displacement amount of the air volume flowmeter in the longitude and latitude directions is set (i.e., in the controlling, monitoring, and analysis unit A, setting each moving displacement size of the air volume flowmeter in the transverse (the X axis direction is the latitude direction) and the vertical (the Y axis direction is the longitude direction) directions, i.e., respectively setting each angular displacement amount of the transverse stepping motor and the vertical stepping motor; where each angular displacement amount in the two directions can be the same or can be different).
2) The controlling, monitoring, and analysis unit A collects the specific load value of the air duct.
3) The controlling, monitoring, and analysis unit A first controls the air volume flowmeter from an initial position to a longitude movement by a preset angular displacement amount, then controls the air volume flowmeter to measure all the latitude preset point wind speed values (i.e., the differential pressure values) one by one in the latitude direction, and at the same time, sends the air volume measured at the corresponding preset point to the air volume transmitter. Then the air volume transmitter stores the air volume electrical signal thereof, a position signal thereof, and a specific load value in the controlling, monitoring, and analysis unit A in one-to-one correspondence (i.e., the controlling, monitoring, and analysis unit A first controls the vertical stepping motor to move a preset angular displacement amount, and then controls the transverse stepping motor to drive the upper fixed puller to drive the transverse rotating steel wire 4-2-6 to rotate a preset angular displacement amount. In this way, the air volume flowmeter is driven to transversely measure the wind speed value of all the preset points in the transverse direction one by one (i.e., the pressure difference), at the same time, the air volume measured at the corresponding preset point is sent to the air volume transmitter, and then the air volume transmitter stores its air volume electrical signal, its position signal, and the specific load value in the controlling, monitoring, and analysis unit A in one-to-one correspondence).
4) The controlling, monitoring, and analysis unit A further controls the air volume flowmeter to move a preset angular displacement amount in the longitude direction, and step 3 is circulated, until the air volume flowmeter measures all preset point wind speed values in the rectangular air duct in an all-around manner.
5) The air duct load values in step 2 (such as 35%, 40%, 50%, 60%, 70%, 80%, 90%, and 100%) are adjusted one by one; steps 2, 3, and 4 are repeated until all the preset point wind speed values of the air duct under the measured air duct load values (uniformly selecting load values within the allowable range of the air duct load values, such as 35%, 40%, 50%, 60%, 70%, 80%, 90% and 100% load) are completed.
6) The controlling, monitoring, and analysis unit A respectively accumulates all the preset point wind speed values of different load values of the air duct monitored above, and then divides them by the number of the preset points to calculate the data average wind speed value under each load value, and then the data average wind speed error of the set air duct is gradually increased from zero to until at least one common preset point is determined, which is the data average wind speed value point of the air duct. The wind speed measurement values of the common preset point are all within the range of the sum of the set air duct data average wind speed errors after the data average wind speed value in each load value is increased.

In addition, this embodiment further provides the air volume measurement system provided with the air volume flowmeter based on a data average wind speed value point: setting the air volume flowmeter on each data average wind speed value point determined according to the method of determining the data average wind speed value point; since the measured wind speed values of each data average wind speed value point are basically consistent, nearly no air flowing would be generate between the air volume flowmeters of the data average wind speed value points; and the wind speed value measured by the air volume flowmeter of each data average wind speed value point is equalized through the equalizer, then is connected with the air volume transmitter, and then forms, together with the controlling, monitoring, and analysis unit A, the air volume measurement system provided with the air volume flowmeter set based on the data average wind speed value point. Certainly, the above-mentioned air volume flowmeters of the data average wind speed value point can also be respectively connected to the air volume transmitter, without average pressure by the equalizers, so that the air volume measurement system measures the air volume more accurately.

Since the air duct is under different load values, its wind fields are all non-uniform wind fields. Through the above-mentioned method, specific common points where the data average wind speed value within the cross section of the air duct is located can be accurately found, and the air volume flowmeter is set on these points, so that the air volume of the air duct can be measured in real time and accurately.

Next, on the basis of the air volume measurement system based on big data analysis and the air volume measurement system provided with the air volume flowmeter based on the data average wind speed value point, this embodiment provides a correction system that combines the air volume measurement system based on big data analysis and the air volume measurement system provided with the air volume flowmeter based on the data average wind speed value point. The correction system includes a big data air volume dynamic longitude and latitude sensing device arranged in the cross section of the air duct, the air volume flowmeter set at least one data average wind speed value point on the cross section of the misaligned air duct, the air volume transmitter connected with them respectively, and controlling, monitoring, and analysis units A and B. Certainly, in order to ensure reliable measurement results of air volume of the air duct, this correction system can also run the air volume measurement system based on big data analysis and the air volume measurement system provided with the air volume flowmeter based on the data average wind speed value point at the same time, wherein one is used and the other one is backup, to ensure the reliable and accurate measurement of the air volume of the air duct.

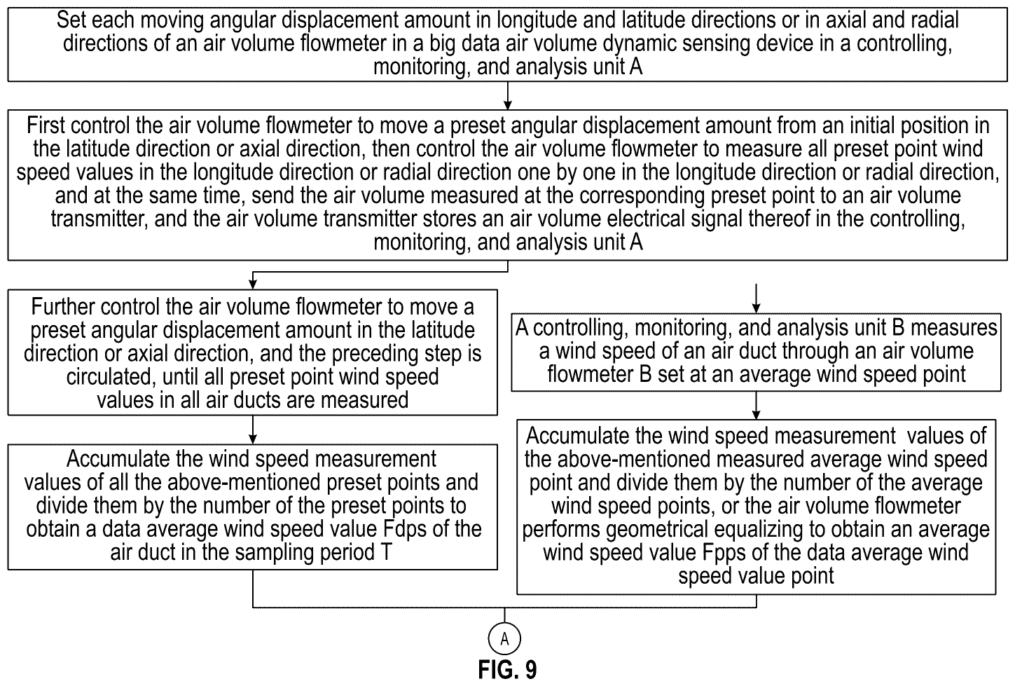

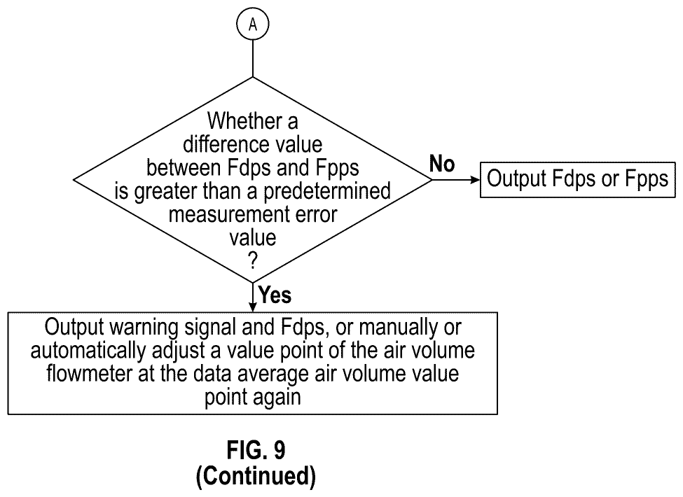

Finally, based on the aforementioned correction system, this embodiment provides a correction method of combining the air volume measurement system based on big data analysis and the air volume measurement system provided with the air volume flowmeter based on a data average wind speed value point; as shown in FIG. 9, it is a flow chart of a correction method of combining the air volume measurement system based on big data analysis and the air volume measurement system provided with the air volume flowmeter based on a data average wind speed value point. The method thereof is to use at least one data air volume dynamic longitude and latitude sensing device set in the cross section of the air duct to carry out the all-around dynamic point-by-point wind speed measurement at preset point intervals in each sampling period, and then the sum of the wind speed measurement values of all the preset points are divided by the number of the preset points to obtain the data average wind speed value Fdps of the air duct (the specific air volume measurement method is described and detailed in the flow chart of the air volume measurement method based on big data analysis of the air duct of the non-uniform wind field in FIG. 7 and its description). At the same time, by setting up the air volume flowmeter at least one data average wind speed value point to measure the wind speed in real time, and then the above wind speed measurement values are accumulated and divided by the number of the average wind speed value points or geometric pressure balancing, the average wind speed value Fpps of the data average wind speed value point of the air duct is obtained; and then, the difference value between the data average wind speed value Fdps of the air duct and the average wind speed value Fpps at the data average wind speed value point of the air duct is calculated. When the above-mentioned difference value is greater than the predetermined measurement error value, the warning signal is output and the data average wind speed value Fdps of the air duct is used. When the above-mentioned difference value is less than the predetermined measurement error value, a normal signal is output and one of the data average wind speed value Fdps of the air duct and the average wind speed value Fpps of the data average wind speed point of the air duct is adopted. When the above-mentioned difference value is greater than a predetermined measurement error value, a warning signal can also be output to manually or automatically adjust a setting position of the air volume flowmeter of the data average wind speed value point again. The predetermined measurement error value is not greater than 2% (i.e., an industrial air volume measurement second level accuracy requirement).

Certainly, in order to ensure reliable measurement results of air volume of the air duct, this correction method can also run the air volume measurement system based on big data analysis and the air volume measurement system provided with the air volume flowmeter based on the data average wind speed value point at the same time, for mutual verification, to ensure the reliable and accurate measurement of the air volume of the air duct.

### Simulation Experiment

Based on the air volume measurement system of the above-mentioned big data air volume dynamic longitude and latitude sensing device, the rectangular air duct in this simulation experiment simulates the rectangular air duct of 300 MW coal-fired generating set and the following simulation air volume measurement experiment is conducted:

### (I) Simulation Experiment System Introduction

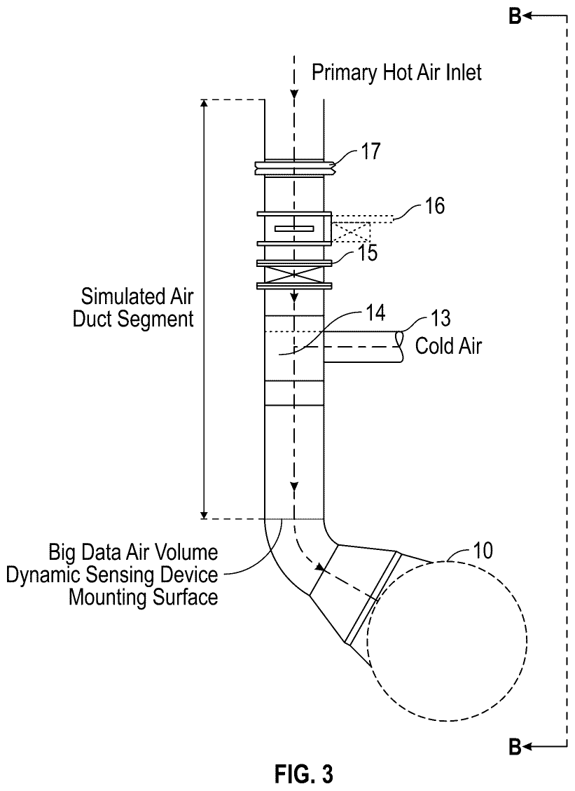

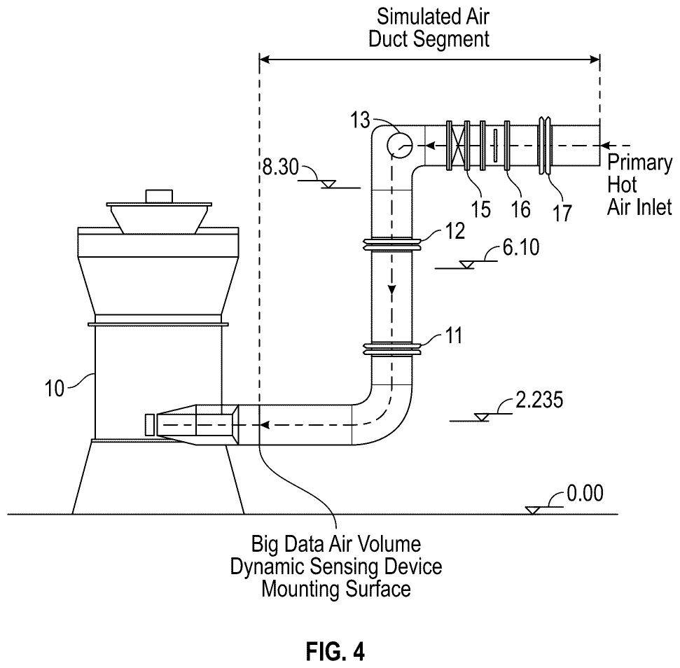

FIGS. 3 and 4 are schematic diagrams of the simulated air duct structure of the air volume measurement system based on big data analysis. The simulated air duct segment is a primary hot air rectangular air duct segment of the 300 MW coal-fired generating unit entering the ball mill 10, and the simulation ratio between the actual air duct and the simulated air duct is 2:1. At the same time, an expansion joint A 11, an expansion joint B 12, a cold air pipe 13, a cold air port 14, a shut-off valve 15, an adjusting valve 16, and an expansion joint C 17 in the actual air duct are eliminated to fabricate a simulated air duct with a simple structure. At the same time, a fan is set at a primary hot air inlet, and a big data air volume dynamic longitude and latitude sensing device is installed in the cross section of the simulated air duct close to the ball mill 10 (i.e., the big data air volume dynamic longitude and latitude sensing device shown in FIGS. 1 and 2). In the drawings, 0.00, 2.235, 6.10, and 8.30 are the elevation of 0.00 m, 2.235 m, 6.10 m, and 8.30 m, respectively.

According to wind speed requirements of the simulated air duct, the fan is selected: Shanghai Halong Fan Electric Co., LTD.; fan model: 4-72; air volume: 10562-3712 m³/h; and full pressure 1673/2554 Pa. Its frequency regulation and speed regulation device is configured: ABB Company; inverter product model: ACSS10; and meeting a range of 25-100% wind speed regulation. At the same time, according to the size of the cross section of the simulated air duct, the above-mentioned big data air volume dynamic longitude and latitude sensing device in a proper size is designed and installed on the cross section in the simulated air duct. The air volume flowmeter in the big data air volume dynamic longitude and latitude sensing device is in the model and specification: AFM-110 type insertion multi-throat flow measurement device (i.e., the air volume flowmeter); and a ROSEMOUNT 3051 CDOA02A1A1H2B3M5 series intelligent differential pressure transmitter (i.e., the air volume transmitter) connected therewith is optionally selected: range: 0-5171 kPa; power supply: 10.5-55 VDC; serial number: 27315068110; calibration: 0-747 Pa; and output: 4-20 mA. The controlling, monitoring, and analysis unit A includes: 1) one longitude and latitude movement control data storage box, with its specification: Kumei CM6024; and 2) one Lenovo notebook and a set of air volume measurement cross section flow field visualization analysis and optimization point selection software. The transverse stepping motor and the vertical stepping motor are optionally equipped with a Raisai intelligent 57CME26 stepping motor. The differential pressure transmitter transmits air volume measurement data corresponding to each preset point under the monitored air duct load value to the longitude and latitude movement control data storage box through a data line. The load value, the preset point, and the corresponding air volume measurement value in the longitude and latitude movement control data storage box are transmitted to the Lenovo notebook one by one, and the air volume measurement cross section flow field visualization analysis and optimization point selection software is used for big data analysis and processing.

### (II) Measurement Process and Result of Simulation Experiment

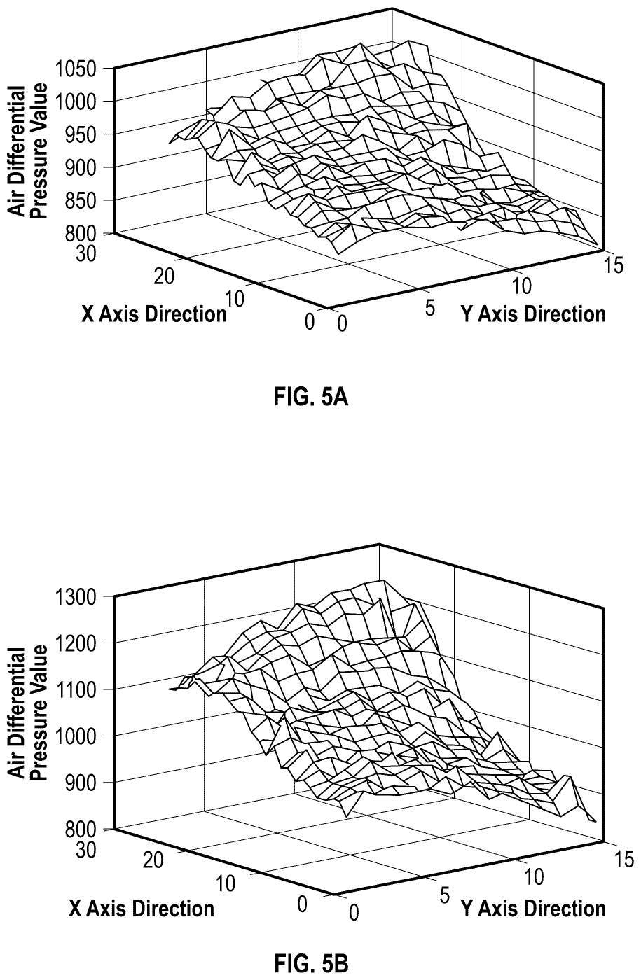

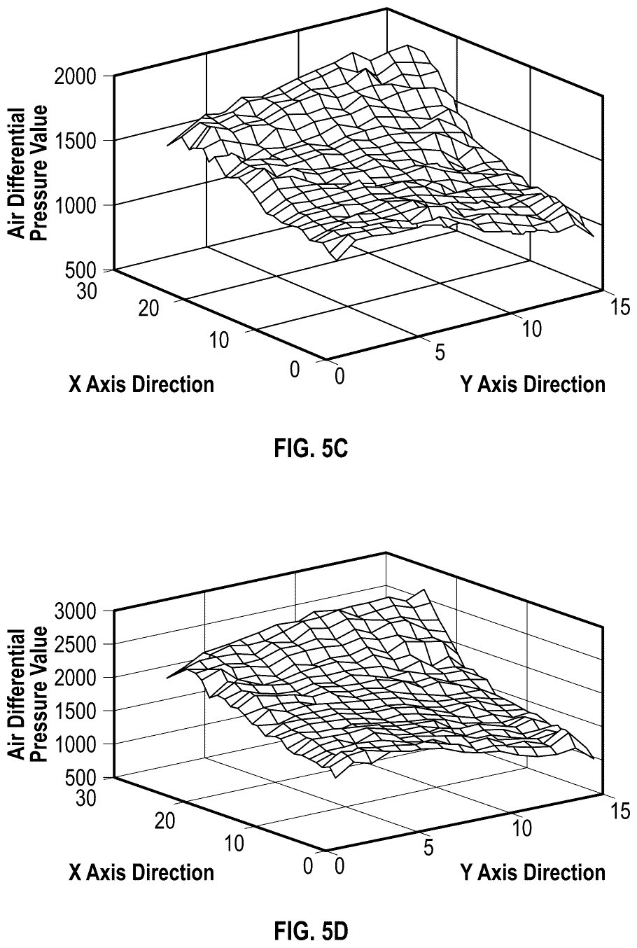

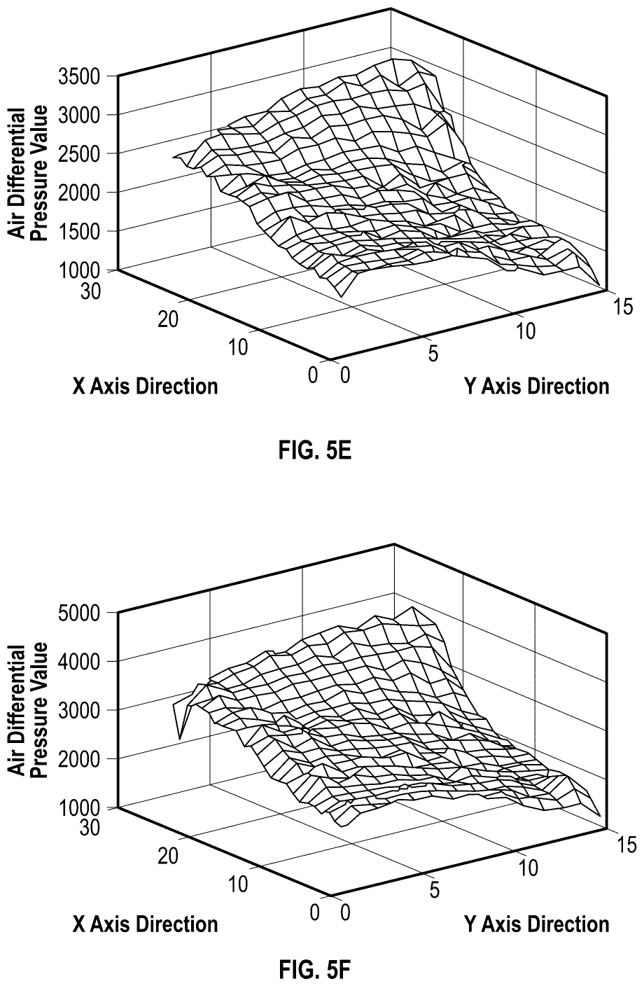

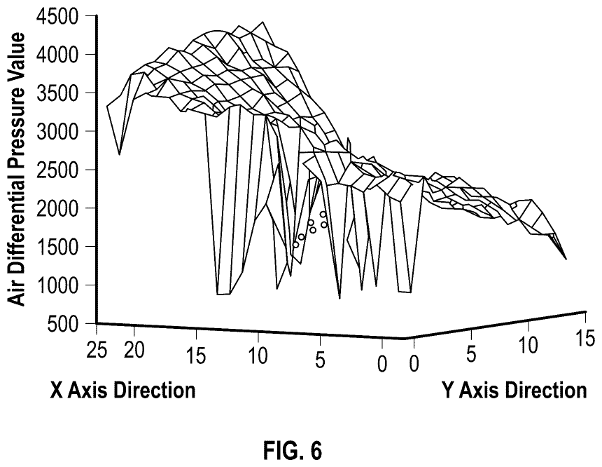

1) Firstly, the number of preset points is set on the cross section measured by the controlling, monitoring, and analysis unit A: xy axis intersection points on the measured cross section by the simulated air duct are preset points: 20 lines divided on the x axis, 6 lines divided on the Y axis, and a total of 120 preset points.
2) Respectively under the load values of 33%, 41.7%, 58.3%, 70%, 87.6%, and 100%, wind speed sampling is conducted at the above-mentioned preset points of the measured cross section. Through the air volume transmitter, the air volume electrical signal at each preset point is transmitted to the controlling, monitoring, and analysis unit A to form a database. After all pre-selected load sampling is completed, the database is imported into the “air volume measurement cross section flow field visualization analysis and optimization point selection software” for analysis and processing to form a cross section-wind speed stereograph wind speed peak map. The size of the wind speed of the sampling point at different positions on the measured cross section under the same load value can be intuitively seen. FIGS. 5a-5f are respectively 3D air volume measurement curve diagrams of the air volume measurement system when the load values are respectively 33%, 41.7%, 58.3%, 70%, 87.6%, and 100%.
3) At the same time, the controlling, monitoring, and analysis unit A calculates the pre-selected data average wind speed value point through image observation and big data: the sum of the measured wind speed at all 120 preset points under a certain load value divided by 120 can obtain the data average wind speed value under the load value. According to the setting that the air duct data average wind speed error is gradually increased by 0, 1/4500, 2/4500, 3/4500, 4/4500 . . . (where 4500 is the measured maximum wind speed value of the above-mentioned simulated air duct), under the measured load value, a plurality of common preset points of xy coordinates corresponding to the measured preset point wind speed value that falls within the data average wind speed error of the set air duct, are determined, that is, the pre-selected point of the data average wind speed value (at least one). FIG. 6 is the 3D curve diagram of selecting the data average wind speed point when the set data average wind speed error of the air volume measurement system based on big data analysis is 6/4500, where 5 black dots in the drawing are the common pre-selected points of 5 data average wind speed values when the set air duct data average wind speed error is 6/4500.

### (III) Simulation Experiment Data Analysis

Certainly, according to the above-mentioned simulated air duct experiment, the data average wind speed value point of the cross section of the air duct is measured, and due to limitations of the simulated air duct simulation ratio and actual air duct apparatus, the support, and on-line sampling load adjustment, the position of the data average wind speed value of the wind field in some loads is affected, and it needs to set the air volume flowmeter at a position corresponding to the cross section of the air duct actually measured for wind speed measurements. Compared with the air volume measurement result of the simulated air duct experiment, the air volume measurement system composed of a dynamic longitude and latitude sensing device based on big data air volume measurement is mounted on the cross section of the air duct according to actual conditions to calibrate or verify the result, to meet the accuracy requirements of air volume measurement in the air duct.

Although the above-mentioned experiment is for the air volume measurement experiment of the simulated air duct, it is completely feasible to use the above-mentioned devices and methods in the actual non-uniform wind field air duct, because in the air duct simulation experiment, the actual air duct is only reduced in a corresponding proportion; and even if the actual air duct is more complex, the wind speed measurement curved surface diagrams of all non-uniform wind field air ducts are irregular 3D curved surface, as long as some data average wind speed value points in the non-uniform wind field air duct can be accurately found (i.e., a group of such positions can be found within a reasonable range of air volume measurement errors), to represent the data average wind speed value points within the cross section of the air duct.

In the technical solution of the present invention, the data average wind speed value point within the cross section of the air duct is found through the simulation experiment or the actual air duct air volume measurement, and then the air volume flowmeter is set on the data average wind speed value point. Compared with the existing air volume measurement technology, it has a targeted point, and subverts the concept in the related art that the geometric average wind speed value represents the actual wind speed value, so as to greatly improve the accuracy of the air volume measurement system.

### Embodiment II

This embodiment provides a big data air volume dynamic longitude and latitude sensing device in a rectangular air duct, which is an optimization on the basis of embodiment I, with the following difference: the latitude driven dynamic air volume sensing part in embodiment I includes a plurality of air volume flowmeters uniformly distributed on the transverse part body, so that the transverse rotating part in embodiment I can be eliminated, i.e., the transverse stepping motor, the upper fixed pulley, the left and right corner fixed pulleys, the left and right transverse fixed pulleys, and the transverse transmission steel wire therebetween them, which can greatly shorten the time required to monitor the air volume of the whole air duct under a specific load value, reduce the sampling period T, and ensure the real-time performance of the measured air volume. For the remaining part, please refer to the corresponding contents of embodiment I.

The rectangular air duct air volume measurement system composed of the big data air volume dynamic longitude and latitude sensing device also includes the same number of air volume transmitters as or the air volume transmitter respectively connected with the plurality of air volume flowmeters in the big data air volume dynamic longitude and latitude sensing device and a controlling, monitoring, and analysis unit A that controls and monitors the big data air volume dynamic longitude and latitude sensing device. To accurately measure the air volume or accurately find the positioning of the data average wind speed value point, the number of the air volume transmitters is the same as that configured for the air volume flowmeters, and they are respectively communicated; certainly, it is only used for relatively accurately perform air volume measurement in the air duct, positive and negative pressure sampling holes of the air volume flowmeter can be respectively communicated on positive and negative equalizers, and are further communicated with one air volume transmitter through the positive and negative equalizers.

Similarly, based on the big data air volume dynamic longitude and latitude sensing device in the rectangular air duct, this embodiment also provides the air volume measurement method based on big data analysis of the air duct of the non-uniform wind field, a method for determining a data average wind speed value point through the aforementioned air volume measurement method based on big data analysis of the non-uniform wind field air duct, the air volume measurement system provided with the air volume flowmeter based on the data average wind speed value point, and a correction system and method of combining the air volume measurement system based on big data analysis and the air volume measurement system provided with the air volume flowmeter based on a data average wind speed value point of the non-uniform wind field air duct; and for the corresponding contents, please refer to corresponding parts of embodiment I.

### Embodiment III

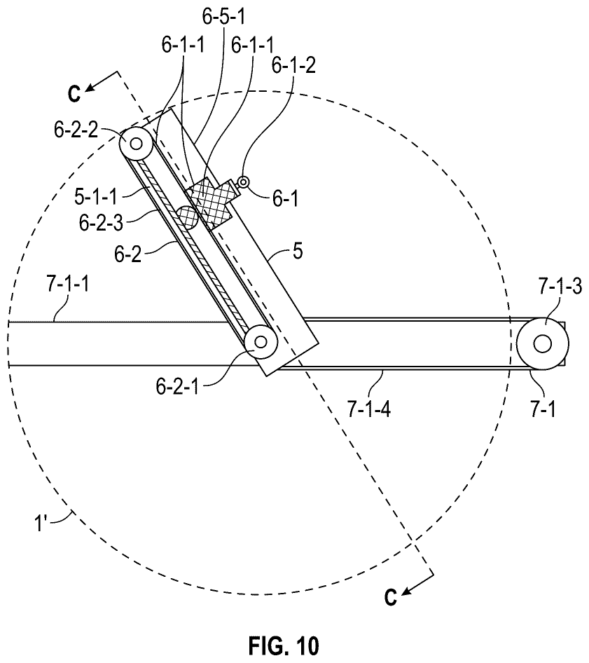

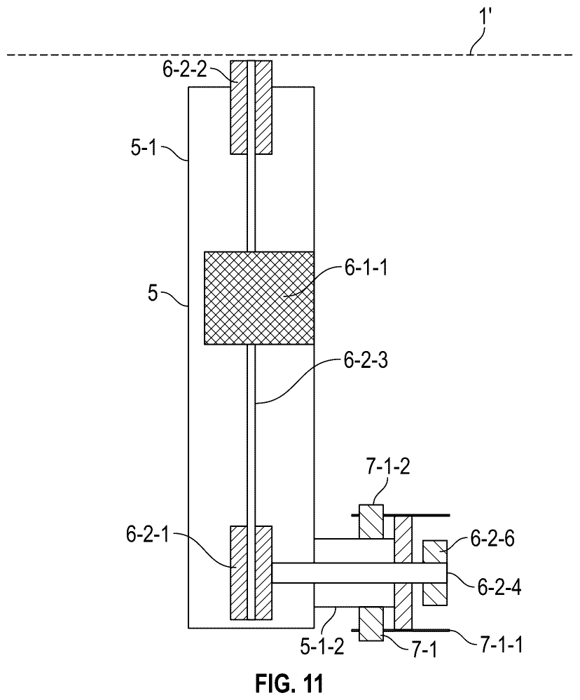

This embodiment provides a big data air volume dynamic axial and radial sensing device in a circular air duct. As shown in FIG. 10 and FIG. 11, it is a schematic diagram of a structure of a big data air volume dynamic axial and radial sensing device disposed in a circular air duct provided by the present invention. A big data air volume dynamic sensing device is a big data air volume dynamic axial and radial sensing device; and the big data air volume dynamic axial and radial sensing device is disposed in a certain cross section of a circular air duct 1′, and includes an axial sensing active part 5, a radial driven air volume sensing part 6 thereof, and an axial sensing active part driving part; the axial sensing active part driving part includes an axial transmission part 7-1 for axially transmitting the axial sensing active part, and an axial driving part. The radial driven air volume sensing part 6 includes a radial dynamic air volume sensing member 6-1 and a radial rotating part 6-2 of the air duct on the axial sensing active part for radially moving the radial dynamic air volume sensing member back and forth.

The axial sensing active part 5 includes an axial sensing active part body 5-1, the cross section of the axial sensing active part body is a C-type structure, an opening thereof is located on a right side thereof, and a transverse track A 5-1-1 is disposed at an inner bottom surface thereof; the radial rotating part 6-2 includes a center fixed pulley 6-2-1 and a circumferential fixed pulley 6-2-2 respectively disposed at both ends of the axial sensing active part body 5-1, a dynamic radial transmission steel wire 6-2-3 therebetween, a static transmission part 6-2-4 for axially driving the center fixed pulley to rotate, and a radial stepping motor for driving same; the radial dynamic air volume sensing member 6-1 is fixed on an opening side of the axial sensing active part body 5-1 and is arranged on the dynamic radial transmission steel wire 6-2-3.

The axial transmission part 7-1 includes an axial transmission part body 7-1-1 with the cross section being an I-shaped structure and a front side located at the center of the circular air duct, a center inner fixed pulley 7-1-2 and a right end inner fixed pulley 7-1-3 respectively disposed at positions of a right end thereof, and a static axial transmission steel wire 7-1-4 therebetween; two ends of the axial transmission part body 7-1-1 are fixed on left and right walls of the circular air duct 1′ through the center of the circular air duct and the right end extends out of the air duct outer wall; the axial driving part is an axial stepping motor, which is fixed on the axial driving part body 7-1-1 and is connected to and drives the right end inner fixed pulley 7-1-3 through a shaft.

The axial sensing active part body 5-1 is also provided with a sleeve 5-1-2 at a center point of the air duct thereof, an end of the sleeve is fixed on the axial sensing active part body at the center point of the circular air duct, and the other end thereof is fixed between inner and outer bearings in a vertical bar of the I-shaped structure of the axial transmission part body 7-1-1; and an inner wall of the center inner fixed pulley 7-1-2 is embedded in an outer wall of the sleeve.

The static transmission part 6-2-4 includes the axial transmission part body 7-1-1 with a rear side located at the center of the circular air duct and a right end respectively provided with a center outer fixed pulley 6-2-6, a right end outer fixed pulley, and a static radial transmission steel wire therebetween; the radial stepping motor is fixed on the axial transmission part body 7-1-1 and is connected to and drives the right end outer fixed pulley through a shaft; and the center outer fixed pulley 6-2-6 is connected to and drives the center fixed pulley 6-2-1 to rotate through a connecting shaft, and the connecting shaft between the center outer fixed pulley and the center fixed pulley is embedded in the inner bearing.

The radial dynamic air volume sensing member 6-1 includes a sliding block A 6-1-1 for sliding along the transverse track A 5-1-1 and one air volume flowmeter A 6-1-2 fixed thereon and located above the C-type structure of the axial sensing active part body.

The circular air duct air volume measurement system composed of the big data air volume dynamic axial and radial sensing device also includes the air volume transmitter connected with the air volume flowmeter A in the big data air volume dynamic axial and radial sensing device and a controlling, monitoring, and analysis unit A that controls and monitors the big data air volume dynamic axial and radial sensing device.

As shown in FIG. 7, this embodiment is a flow chart of the air volume measurement method of the air duct of a non-uniform wind field provided based on the circular air duct air volume measurement system, and the steps thereof are as follows:
1) In the controlling, monitoring, and analysis unit A, each angular displacement amount of the air volume flowmeter A in the axial and radial directions is set (i.e., in the controlling, monitoring, and analysis unit A, setting the size of each angular displacement and each line displacement of the air volume flowmeter A in the radial direction and axial direction, i.e., respectively setting each angular displacement amount of the radial stepping motor and the axial stepping motor; where each angular displacement amount in the two directions can be the same or can be different).
2) The controlling, monitoring, and analysis unit A first controls the air volume flowmeter A from an initial position to an axial movement by a preset angular displacement amount, then controls the air volume flowmeter A to measure all the radial preset point wind speed values (i.e., the differential pressure values) one by one in the radial direction, and at the same time, sends the air volume measured at the corresponding preset point to the air volume transmitter. Then the air volume transmitter stores the air volume electrical signal thereof in the controlling, monitoring, and analysis unit A (i.e., the controlling, monitoring, and analysis unit A first controls the axial stepping motor to move a preset angular displacement amount, and then controls the radial stepping motor to drive the air volume flowmeter A in the radial rotating part 6-2 to radially measure the wind speed value of all the preset points in the transverse direction one by one, at the same time, the wind speed value measured at the corresponding preset point (i.e., the pressure difference) is sent to the air volume transmitter, and then the air volume transmitter stores its air volume electrical signal in the controlling, monitoring, and analysis unit A).
3) The controlling, monitoring, and analysis unit A further controls the air volume flowmeter A to move a preset angular displacement amount in the axial direction, and step 2 is circulated, until the air volume flowmeter A measures all preset point wind speed values in the circular air duct.
4) The controlling, monitoring, and analysis unit accumulates the measured wind speed values of all the above-mentioned preset points and divided them by the number of the preset points to obtain the data average wind speed value of the air duct in the sampling period T, where this value is the measured value of air volume in the air duct.

The wind speed measurement of all the preset points in the whole circular air duct above requires a sampling period T, but the size of the sampling period T is determined by the size of the axial stepping motor and radial stepping motor speed, the size of the circular air duct, the number of preset points of the circular air duct, the size of the wind speed of the circular air duct, and other factors. The shorter the sampling period T, the more accurate the data average wind speed value of the air duct above. However, when the air duct load value is constant, the size of the data average wind speed value of the air duct above is irrelevant with the sampling period T.

The preset point interval is determined by the size of the air duct, the complexity of the wind field, the accuracy of the air volume measurement thereof, and other requirements.

As shown in FIG. 8, this embodiment further provides a flow chart of a method for determining a data average wind speed value point through the air volume measurement method of the air duct of the non-uniform wind field based on the circular air duct air volume measurement system, and the steps thereof are as follows:
1) In the controlling, monitoring, and analysis unit A, each angular displacement amount of the air volume flowmeter A in the axial and radial directions is set (i.e., in the controlling, monitoring, and analysis unit A, setting the size of each line displacement and each angular displacement of the air volume flowmeter A in the radial direction and axial direction, i.e., respectively setting each angular displacement amount of the radial stepping motor and the axial stepping motor; where each angular displacement amount in the two directions can be the same or can be different).
2) The controlling, monitoring, and analysis unit A collects the specific load value of the air duct.
3) The controlling, monitoring, and analysis unit A first controls the air volume flowmeter A from an initial position to an axial movement by a preset angular displacement amount, then controls the air volume flowmeter A to measure all the radial preset point wind speed values (i.e., the differential pressure values) one by one in the radial direction, and at the same time, sends the air volume measured at the corresponding preset point to the air volume transmitter. Then the air volume transmitter stores the air volume electrical signal thereof, a position signal thereof, and a specific load value in the controlling, monitoring, and analysis unit A in one-to-one correspondence (i.e., the controlling, monitoring, and analysis unit A first controls the axial stepping motor to move a preset angular displacement amount, and then controls the radial stepping motor to drive the air volume flowmeter A in the radial rotating part 6-2 to radially measure all the preset point wind speed values (i.e., the differential pressure values) in the radial direction one by one, at the same time, the air volume measured at the corresponding preset point is sent to the air volume transmitter, and then the air volume transmitter stores the air volume electrical signal thereof, the position signal thereof, and the specific load value in the controlling, monitoring, and analysis unit A in one-to-one correspondence).
4) The controlling, monitoring, and analysis unit A further controls the air volume flowmeter A to move a preset angular displacement amount in the axial direction, and step 3 is circulated, until the air volume flowmeter A measures all preset point wind speed values in the circular air duct.
5) The air duct load values in step 2 (such as 35%, 40%, 50%, 60%, 70%, 80%, 90%, and 100%) are adjusted one by one; steps 2, 3, and 4 are repeated until all the preset point wind speed values of the air duct under the measured air duct load values (i.e., uniformly selecting load values within the allowable range of the air duct load values, such as 35%, 40%, 50%, 60%, 70%, 80%, 90% and 100% load) are completed.
6) The controlling, monitoring, and analysis unit A respectively accumulates all the preset point wind speed values of different load values of the air duct monitored above, and divides them by the number of the preset points to calculate the data average wind speed value under each load value, and then the data average wind speed error of the set air duct is gradually increased from zero to until at least one common preset point is determined. The wind speed measurement values of the common preset point are all within the range of the sum of the set air duct data average wind speed errors after the data average wind speed value in each load value is increased.

In addition, this embodiment provides the air volume measurement system provided with the air volume flowmeter based on a data average wind speed value point: setting the air volume flowmeter on each data average wind speed value point determined according to the method of determining the data average wind speed value point; since the measured wind speed values of each data average wind speed value point are basically consistent, nearly no air flowing would be generate between the air volume flowmeters of the data average wind speed value points; and the wind speed value measured by the air volume flowmeter of each data average wind speed value point is equalized, is connected with the air volume transmitter, and then forms, together with the controlling, monitoring, and analysis unit A, the air volume measurement system provided with the air volume flowmeter set based on the data average wind speed value point. Certainly, the above-mentioned air volume flowmeters of the data average wind speed value point can also be respectively connected to the air volume transmitter, so that the air volume measurement system measures the air volume value more accurately.

Since the air duct is under different load values, its wind fields are all non-uniform wind fields. Through the above-mentioned method, specific common points where the data average wind speed value in the cross section of the air duct is located can be accurately found, and the air volume flowmeter is set on these points, so that the air volume of the air duct can be measured in real time and accurately.

Next, on the basis of the air volume measurement system based on big data analysis and the air volume measurement system provided with the air volume flowmeter based on the data average wind speed value point, this embodiment further provides a correction system that combines the air volume measurement system based on big data analysis and the air volume measurement system provided with the air volume flowmeter based on the data average wind speed value point. The correction system includes a big data air volume dynamic axial and radial sensing device arranged in the cross section of the air duct, the air volume flowmeter set at least one data average wind speed value point on the cross section of the misaligned air duct, the air volume transmitter connected with them respectively, and controlling, monitoring, and analysis units. Certainly, in order to ensure reliable measurement results of air volume of the air duct, this correction system can also run the air volume measurement system based on big data analysis and the air volume measurement system provided with the air volume flowmeter based on the data average wind speed value point at the same time, wherein one is used and the other one is backup, to ensure the reliable and accurate measurement of the air volume of the air duct.

Finally, based on the afore-mentioned correction system, this embodiment further provides a correction method of combining the air volume measurement system based on big data analysis and the air volume measurement system provided with the air volume flowmeter based on a data average wind speed value point. As shown in FIG. 9, it is a flow chart of a correction method of combining the air volume measurement system based on big data analysis and the air volume measurement system provided with the air volume flowmeter based on a data average wind speed value point. The method thereof is to use the air volume flowmeter A in at least one data air volume dynamic axial and radial sensing device set in the cross section of the air duct to carry out the all-around dynamic point-by-point wind speed measurement at preset point intervals in each sampling period, and then the sum of the wind speed measurement values of all the preset points are divided by the number of the preset points to obtain the data average wind speed value Fdps of the air duct (the specific air volume measurement method is described and detailed in the flow chart of the air volume measurement method based on big data analysis of the air duct of the non-uniform wind field in FIG. 7 and its description). At the same time, the air volume flowmeter set in at least one data average wind speed value point is set in the cross section of the air duct to measure the air volume in real time, and then the wind speed measurement value of the above-mentioned measured average wind speed value point is accumulated and divided by the number of the average wind speed value points thereof, and the data average wind speed value point average wind speed value Fpps is obtained after geometric equalizing; and then, the different value between the data average wind speed value Fdps of the air duct and the average wind speed value Fpps at the data average wind speed value point of the air duct is calculated. When the above-mentioned difference value is greater than the predetermined measurement error value, the warning signal is output and the data average wind speed value Fdps of the air duct is used. When the above-mentioned difference value is less than the predetermined measurement error value, a normal signal is output and one of the data average wind speed value Fdps of the air duct and the average wind speed value Fpps of the data average wind speed point of the air duct is adopted. When the above-mentioned difference value is greater than a predetermined measurement error value, a warning signal can also be output to manually or automatically adjust a setting position of the air volume flowmeter A of the data average wind speed value point again. The predetermined measurement error value is not greater than 2% (i.e., an industrial measurement accuracy second level requirement).

Certainly, in order to ensure reliable measurement results of air volume of the air duct, this correction method can also run the air volume measurement system based on big data analysis and the air volume measurement system provided with the air volume flowmeter based on the data average wind speed value point at the same time, for mutual verification, to ensure the reliable and accurate measurement of the air volume of the air duct.

### Embodiment IV

This embodiment provides a big data air volume dynamic axial and radial sensing device in a circular air duct, which is an optimization on the basis of embodiment III, with the following difference: the radial driven air volume sensing part in embodiment III includes a plurality of air volume flowmeters A arranged radially and uniformly distributed on the axial sensing active part body. Hence, the radial rotating part 6-2 in embodiment I can be eliminated, which can greatly shorten the time required to monitor the air volume of the whole air duct under a specific load value, reduce the sampling period T, and ensure the real-time performance of the measured air volume. For the remaining part, please refer to the corresponding contents of embodiment III.

The circular air duct air volume measurement system composed of the big data air volume dynamic sensing device also includes the air volume transmitter respectively connected with a plurality of air volume flowmeters A in the big data air volume dynamic axial and radial sensing device and a controlling, monitoring, and analysis unit A that controls and monitors the big data air volume dynamic axial and radial sensing device. To accurately measure the air volume or accurately position the data average wind speed value point, the number of the air volume transmitters is the same as that configured for the air volume flowmeters A, and they are respectively communicated; certainly, it is only used for relatively accurately perform air volume measurement, positive and negative pressure sampling holes of the air volume flowmeter A can be respectively communicated on positive and negative equalizers, and are further communicated with one air volume transmitter through the positive and negative equalizers.

Similarly, based on the big data air volume dynamic axial and radial sensing device in the circular air duct, this embodiment also provides the air volume measurement method of the air duct of the non-uniform wind field, a method for determining a data average wind speed value point through the aforementioned air volume measurement method of the non-uniform wind field air duct, the air volume measurement system provided with the air volume flowmeter based on the data average wind speed value point, and a correction system and method of the air volume measurement system based on big data and the air volume measurement system provided with the air volume flowmeter based on a data average wind speed value point; and for the corresponding contents, please refer to corresponding parts of embodiment III.

The air volume flowmeter in the big data air volume dynamic sensing device recited in the present invention is an AFM-110 type insertion multi-throat flow measurement device; other Ventury-type air volume flowmeters can also be selected, such as single-throat pipe, double-throat pipe, multi-throat pipe, and other air volume flowmeters; and a Pitot tube air volume flowmeter can also be selected.

If the big data air volume dynamic sensing device in the present invention is installed in a dust air duct, a back purge device used for measuring a gas pipeline in Chinese patent CN111520611A can be used to solve the problem that the air volume flowmeter in the big data air volume dynamic sensing device is blocked by dust, rendering inaccurate air volume measurement in the air duct.

Although the above-mentioned embodiments are examples of big data air volume dynamic sensing devices designed for air ducts in specific shapes, such as rectangles and circles, to explain the present invention, it should be understood that at the same time, the inventive point of the present invention is: the big data air volume dynamic sensor device presets the number of uniformly distributed preset points in the air duct to measure the wind speed in the cross section of the air duct in an all-around manner, and carries out massive big data monitoring and analysis to obtain the data average wind speed value of the air duct and its corresponding point (certainly, the basic uniformly distributed preset points in the air duct can also be used, as long as the data average wind speed value of the air duct and its points can be obtained by all-around wind speed measurement). Moreover, the air volume measurement system composed of the air volume flowmeter and the like, the method thereof, the correction system, and the method thereof are provided, for the purpose of: finding the data average wind speed value through big data sampling and analysis, and using the data average wind speed value to replace the geometric average wind speed value in the related art to accurately measure the wind speed of the air duct. A function thereof is to solve the problem of inaccurate air volume measurement in the air duct in the related art, which greatly improves the accuracy of air volume measurement in the air duct; and an effect thereof is: more accurately achieving the best air coal ratio requirements of the coal-fired boiler, so that (1) safety aspect: by improving the real-time accuracy of air volume measurement and operation of the boiler, the safety of the operation is greatly improved; (2) energy saving aspect: no excess air enters, which reduces continuous smoke losses, so as to improve the boiler combustion efficiency; (3) environmental protection aspect: eliminating a peroxide environment of a furnace, and preventing generation of nitrogen oxides at 1200° high temperature in the center of the furnace, which greatly reduces air pollution; and (4) aspect of improving the flexible power generation capability of the coal-fired generating unit: precise oxygen supply, which can greatly improve the flexibility of the generating unit and earn additional electricity price subsidies. Although the above-mentioned effects only show the effect of using the technical solution of the present invention for the air duct of the coal-fired boiler, of course, the technical solution of the present invention is also feasible for other air ducts requiring accurate measurement of air volume. A person skilled in the art may change or improve the present invention without deviating from the essence spirits and scope of the above-mentioned invention points of the present invention, but all of them shall fall within the protection scope of the technical solutions of the present invention.

1. A method for determining a data average wind speed value point in a cross section of an air duct in a non-uniform wind field, comprising:
using, by a controlling, monitoring, and analysis unit A, an air volume flowmeter set in a big data air volume dynamic sensing device in a cross section of an air duct to measure a wind speed for one time in an all-around dynamic point-by-point manner at a provided preset point interval, and convert same into an electrical signal air volume value through an air volume transmitter at the same time, and then store an air duct load value, a preset point of the air duct thereof, and the measured electrical signal air volume value during a sampling period in the controlling, monitoring, and analysis unit A in a one-to-one correspondence, until the measured air duct load value changes once and the wind speed measurement is completed;
calculating, by the controlling, monitoring, and analysis unit A, the data average wind speed value under the monitored load value, respectively: accumulating the wind speed values of the preset points under the monitored load value respectively, and then dividing by a number of the preset point respectively; and
adjusting and setting a data average wind speed error value of the air duct to be gradually increased from zero, until at least one preset point under the monitored load value falls within a range of the data average wind speed error value of the air duct, wherein the preset point is the data average wind speed value point,
wherein the air duct in the non-uniform wind field is an intake duct of a coal-fired boiler for a coal-fired generating unit.

2. The method according to claim 1, wherein there are at least two data average wind speed value points.

3. The method according to claim 1, wherein a value range of the monitored load values is 35%-100%, and at least one monitored load value is selected within the value range.

4. The method according to claim 3, wherein 7 different load values are selected in a uniformly distributed manner in the value range of the monitored load values.

5. The method according to claim 1, wherein the big data air volume dynamic sensing device comprises a sensing active part, a driven air volume sensing part thereof, and a sensing active part driving part; wherein the sensing active part driving part comprises a transmission part for transmitting the sensing active part and a driving part thereof; the driven air volume sensing part comprises a dynamic air volume sensing member and a rotating part for moving the dynamic air volume sensing member back and forth on the sensing active part; or the driven air volume sensing part comprises a plurality of air volume flowmeters uniformly distributed on the sensing active part.

6. The method according to claim 5, wherein the big data air volume dynamic sensing device is a big data air volume dynamic longitude and latitude sensing device or a big data air volume dynamic axial and radial sensing device.

7. The method according to claim 6, wherein the big data air volume dynamic longitude and latitude sensing device comprises a longitude sensing active part, a latitude driven air volume sensing part thereof, and a longitude sensing active part driving part; and the longitude sensing active part driving part comprises a vertical transmission part and a vertical driving part for transmitting the longitude sensing active part in a longitude direction.

8. The method according to claim 7, wherein the latitude driven air volume sensing part comprises a latitude dynamic air volume sensing member, and a transverse rotating part for transversely moving the latitude dynamic air volume sensing member back and forth on the air duct on the longitude sensing active part.

9. The method according to claim 8, wherein the latitude dynamic air volume sensing member comprises a sliding block and an air volume flowmeter fixed thereon.

10. The method according to claim 7, wherein the latitude driven air volume sensing part comprises a plurality of air volume flowmeters uniformly distributed on the longitude sensing active part.

11. The method according to claim 10, wherein a number of the air volume transmitters is the same as a number of the air volume flowmeters, and they are respectively communicated with respective a sampling pipe.

12. The method according to claim 9, wherein the air volume flowmeter is at least one of a Pitot tube air volume flowmeter and a Venturi type air volume flowmeter.

13. The method according to claim 12, wherein the Venturi type air volume flowmeter is at least one of a single-throat pipe air volume flowmeter, a double-throat pipe air volume flowmeter, and a multi-throat pipe air volume flowmeter.

14. The method according to claim 8, wherein the longitude sensing active part comprises a transverse part and a vertical part; a cross section of a transverse part body of the transverse part is an inverted C-type structure; a vertical part body of the vertical part is a long strip shaped closed housing; the transverse part body and the vertical part body are welded together to form an inverted T-type structure; the transverse rotating part comprises left and right transverse fixed pulleys respectively disposed at two ends of the transverse part body and exposed from a top surface of the transverse part body, left and right corner fixed pulleys respectively disposed at two inner sides of a lower end of the vertical part body, an upper fixed pulley disposed at an inner sider of an upper end thereof, a transverse rotating steel wire wound on the left and right transverse fixed pulleys, the left and right corner fixed pulleys, and the upper fixed pulley, and a transverse stepping motor for driving the upper fixed pulley; and the latitude dynamic air volume sensing member is fixed at a lower end of the transverse part body and disposed on the transverse rotating steel wire.

15. The method according to claim 14, wherein the vertical transmission part comprises a vertical transmission part body, upper and lower fixed seats with bearings respectively at upper and lower ends thereof, and a vertical screw fixed in the bearings of the upper and lower fixed seats; an upper end of the transverse part body is further provided with a nut in threaded connection with the vertical screw; and the driving part is a vertical stepping motor, the vertical stepping motor is fixed on an upper end surface of the vertical transmission part body and axially drives the vertical screw.

16. The method according to claim 10, wherein the longitude sensing active part comprises a transverse part and a vertical part; a cross section of a transverse part body of the transverse part is an inverted C-type structure; a vertical part body of the vertical part is a long strip shaped closed housing; the transverse part body and the vertical part body are welded together to form an inverted T-type structure; and the air volume flowmeter is fixed at a lower end of the transverse part body.

17. The method according to claim 16, wherein the vertical transmission part comprises a vertical transmission part body, upper and lower fixed seats with bearings respectively in upper and lower ends thereof, and a vertical screw fixed in the bearings of the upper and lower fixed seats; an upper end of the transverse part body is further provided with a nut in threaded connection with the vertical screw; and the driving part is a vertical stepping motor, and the vertical stepping motor is fixed on an upper end surface of the vertical transmission part body and axially drives the vertical screw.
